(19) United States
(12) Patent Application Publication
(10) Pub. No.: US 2013/0293609 A1
(43) Pub. Date: Nov. 7, 2013

(54) INKJET RECORDING APPARATUS

(71) Applicant: Masakatsu Ohkawa, Tomi-city (JP)

(72) Inventor: Masakatsu Ohkawa, Tomi-city (JP)

(73) Assignee: MIMAKI ENGINEERING CO., LTD., Tomi-city (JP)

(21) Appl. No.: 13/880,738

(22) PCT Filed: Oct. 21, 2011
(86) PCT No.: PCT/JP2011/074353

§ 371 Date: Jul. 24, 2013

(30) Foreign Application Priority Data
Oct. 22, 2010 (JP) 2010-237443

(51) Int. Cl. B41J 2/01

(52) U.S. Cl. CPC B41J 2/01
USPC 347/9

(57) ABSTRACT

An inkjet recording apparatus 1 which is able to print glossy images is provided. The apparatus includes a carriage 4 moving back and forth in a main scanning direction, a plurality of inkjet heads 5 mounted on the carriage 4 for discharging ink droplets in a medium, and an ultraviolet irradiator 6 mounted on the carriage for irradiating ultraviolet rays. The irradiator 6 includes a plurality of UVLEDs 63 which are arranged in a sub-scanning direction in a concave portion formed on the bottom side of the irradiator 6, and each partition wall 64 is provided between two adjacent UVLEDs 63. While the second discharge area A2 of the inkjet heads 5 discharges clear ink on corresponding bands, the UVLEDs 63e-63h which irradiate ultraviolet rays on the bands are turned off. Since the clear ink discharged from the second discharge area A2 and deposited in the medium is not cured immediately but is rather smoothened, the glossiness of the recorded image is enhanced.

### TECHNICAL FIELD

The present disclosure relates to an inkjet recording apparatus discharging ultraviolet-curable ink.

### BACKGROUND ART

Patent Document 1 discloses an inkjet recording apparatus discharging ultraviolet-curable ink. The recording apparatus includes a carriage on which a color ink recording head, a clear ink recording head, and ultraviolet irradiators are mounted. An irradiator is positioned in a downstream region in the moving direction of the recording medium with respect to the color ink recording head, and another irradiator is positioned in a downstream region in the moving direction of the recording medium with respect to the clear ink recording head. The irradiator located between the recording head discharging the ink first and the recording head discharging the ink later controls irradiation intensity.

### PRIOR ART DOCUMENTS

### Patent Documents

Patent Document 1: Japanese Patent Publication No. 2005-199563

### DISCLOSURE OF INVENTION

### Technical Problem

In the inkjet recording apparatus disclosed in Patent Document 1, the clear ink discharging and the ultraviolet irradiation are performed together in a single carriage movement (scan). Therefore, the clear ink droplets are irradiated immediately after being deposited on the recording medium. Since the clear ink is cured before being smoothened (leveling), the surface of the cured ink layer is rough (uneven) and is not glossy.

The inventors of the present disclosure have found after extensive research on the print quality that there is a difference in print quality based on curing conditions of the ultraviolet-curable ink. Particularly, when a glossy image is desired during clear ink recordation, the clear ink deposited on the recording medium should be cured after a predetermined time instead of curing the ink immediately after being deposited.

Therefore, an object of the present disclosure is to provide an inkjet recording medium which is able to print glossy images.

### Technical Solution

An inkjet recording apparatus according to an embodiment of the present disclosure includes a carriage, ink discharging means, ultraviolet irradiating means, and a controller. The carriage moves back and forth in a main scanning direction. The ink discharging means is mounted on the carriage and includes a plurality of ink nozzles arranged in a sub-scanning direction for discharging ultraviolet-curable ink on a recording medium. The ultraviolet irradiating means is mounted on the carriage for irradiating ultraviolet rays on the recording medium. The controller controls the overall operation of the ink discharging means and the ultraviolet irradiating means. The carriage or the medium moves in the sub-scanning direction which is perpendicular to the main scanning direction. The plurality of ink nozzles includes a plurality of path areas to record a plurality of bands, respectively. The ultraviolet irradiating means includes a plurality of light sources irradiating the ultraviolet rays on the plurality of bands, respectively. The controller controls at least one of the light sources for each path area discharging ultraviolet-curable ink.

According to the embodiment, the plurality of light sources of the ultraviolet irradiating means correspond to the plurality of light sources, respectively. Therefore, the ultraviolet irradiation can be controlled for each band. By turning off the light source irradiating on a band corresponding to a path area discharging ink droplets, the ink droplets discharged from the path area and deposited on the recording medium are smoothened instead of being immediately cured. Therefore, the recorded image has sufficient glossiness. In addition, by turning on the light source irradiating on a band corresponding to a path area discharging ink droplets, the ink droplets on the recording medium are cured immediately after being deposited on the recording medium. Therefore, mat images can be printed.

It is preferred that while the carriage moves forward in the main scanning direction, a path area in a downstream region in the sub-scanning direction discharges the ink on a first band, a light source irradiating on the first band is turned off, a path area in an upstream region in the sub-scanning direction discharges no ink on a second band, and a light source irradiating on the second band is turned on. By turning off the light source immediately after the ultraviolet-curable ink is recoded, the ink is smoothened (leveling). Furthermore, the ink is not cured after all the printing areas are recorded by the ink. Rather, there is a time lag of one scan between the recordation and curing. Since the ink is moderately smoothened out, printing errors (offsets) and the curing time are reduced and the effect of the dust on the recorded image can be minimized.

When a color ultraviolet-curable ink is recorded on the medium to form a lower layer and a clear ultraviolet-curable ink is recorded on the lower layer to form an upper layer, it is preferred that a light source irradiating on a band corresponding to a path area discharging the color ink is turned on and a light source irradiating on a band corresponding to a path area discharging the clear ink is turned off. Since the discharged color ink is cured immediately after being deposited on the recording medium, the color ink does not run over the medium and vivid color images can be printed. On the other hand, since the discharged clear ink is smoothened without being cured immediately after being deposited on the medium, the glossiness of the lower layer (color ink layer) is greatly enhanced.

The controller preferably controls such that a path area in a downstream region in the sub-scanning direction discharges the clear ink on a third band, a light source irradiating on the third band is turned off, and a light source irradiating on a fourth band corresponding to a path area in a upstream region in the sub-scanning direction is turned on. By doing so, when the carriage or recording medium is scanned in a direction, the discharged ultraviolet-curable ink droplets are smoothened without being cured immediately after being deposited on the medium and are cured by irradiation during next scans. Since the ink can be cured after being sufficiently smoothened without changing the moving direction of the carriage or medium, efficient recording of glossy images can be made. For example, after an image is formed in a first layer with color ultraviolet-curable ink, the image can be coated in a second layer with clear ultraviolet-curable ink to enhance glossiness of the image. Alternatively, the coating with the clear ink can be made in the first layer to enhance the glossiness of the image.

The controller preferably controls such that first and second light sources irradiating on fifth and sixth bands corresponding to path areas in a upstream region in the sub-scanning direction are turned on, and a light intensity of one of the first and second light sources which is located in a downstream region in the sub-scanning direction is less than a light intensity of the other light source. By doing so, the intensity of the initial irradiation on the clear ink is low, and the intensity of the irradiation on the clear ink is gradually increased in next scans. Therefore, the clear ink can be cured without any image banding due to rapid curing of the clear ink. Furthermore, when the clear ultraviolet-curable ink is recorded on a lower layer of other ultraviolet-curable ink, the adhesivity between two layers is greatly enhanced because the curing speed of the color ink is slower.

The color ultraviolet-curable ink can be recorded on the medium by discharging the color ink on a first band from a path area in a downstream region in the sub-scanning direction, and turning on a light source irradiating on the first band. In addition, clear ultraviolet-curable ink can be recorded on a color ink layer formed by the recorded color ink by discharging the clear ink on a second band from a path area in a downstream region in the sub-scanning direction, turning on a light source irradiating on a third band corresponding to a path area in an upstream region in the sub-scanning direction, and turning off a light source irradiating on the second band.

In this case, the color ink is recorded on the medium first and the color ink is cured by irradiation immediately after being deposited on the medium. Therefore, the ink droplets are cured in a particle shape. The clear ink is recorded on a layer of the color ink, and the clear ink is not irradiated immediately after being deposited on the medium. Therefore, the clear ink is gradually spread out, and the surface thickness is reduced while the surface texture is smoothened. As a result, the visibility and glossiness of the image are enhanced.

The controller preferably controls such that color ultraviolet-curable ink is recorded on the medium by moving the carriage or the medium forward in the sub-scanning direction, discharging the color ink on a first band from a path area in a forward region in the sub-scanning direction, and turning on a light source irradiating on the first band. In addition, clear ultraviolet-curable ink is recorded on a color ink layer formed by the recorded color ink by moving the carriage or the medium backward in the sub-scanning direction, discharging the clear ink on a second band from a path area in a backward region in the sub-scanning direction, turning on a light source irradiating on a third band corresponding to a path area in an upstream region in the sub-scanning direction, and turning off a light source irradiating on the second band.

As described above, the color ink is discharged from the path area located in the forward region in the sub-scanning direction and the clear ink is discharged from the path area located in the backward region in the sub-scanning direction. By doing so, the color ink is recorded on the medium when the carriage or medium moves forward in the sub-scanning direction, and the clear ink is recorded on the color ink layer when the carriage or medium moves backward in the sub-scanning direction. Since forming the image and adding glossiness are performed in a single back-and-forth motion of the carriage or medium, the efficient recordation of glossy image can be made.

In addition, the controller may control such that color ultraviolet-curable ink is recorded on the medium and simultaneously first clear ultraviolet-curable ink is recorded on a color ink layer formed by the recorded color ink by discharging the color ink on a first band from a path area in a downstream region in the sub-scanning direction, discharging the clear ink on a second band from a path area in a upstream region in the sub-scanning direction, and turning on light sources irradiating on the first and second bands. Second clear ultraviolet-curable ink may be recorded on a clear ink layer formed by the recorded first clear ink by discharging the second clear ink on a third band from a path area in a downstream region in the sub-scanning direction, turning on a light source irradiating on a fourth band in a upstream region in the sub-scanning direction, and turning off a light source irradiating on the third band.

As described above, the color ink is recorded on the medium first to form an image, and the upper layer formed by the first clear ink overlaps with the image. Thereafter, the second clear ink is recorded on the upper layer of the first clear ink. Since the first clear ink is cured immediately after being deposited on the medium, the thickness of the ink is increased while the visibility of the image is maintained. Since the second clear ink is not irradiated immediately after being deposited on the first clear ink layer, the second clear ink is gradually spread out and the surface thickness is reduced while the surface texture is smoothened. Therefore, visibility of the recorded is enhanced while the thickness of the ink is increased and the glossiness of the image is enhanced.

The controller preferably controls such that a light source irradiating on a band corresponding to a path area discharging first ultraviolet-curable ink to form a lower layer is turned on and a light source irradiating on a band corresponding to a path area discharging second ultraviolet-curable ink to form an upper layer is turned off. Since the ink recorded in the lower layer is cured in a particle shape, the ink recorded in the upper layer permeates into the ink cured in the particle shape resulting and combines with the adjacent ink droplets to expedite leveling. Therefore, the glossiness of the recorded image is enhanced.

A print method according to another embodiment of the present disclosure includes the steps of recording clear ultraviolet-curable ink on the medium in a current scan by turning off a light source irradiating on a first band corresponding to a path area discharging the clear ink in a downstream region in the sub-scanning direction, and curing the clear ink recorded on the medium in at least one next scan by turning on a light source irradiating on a second band corresponding to a path area in a upstream region in the sub-scanning direction.

In the print method, the ink droplets discharged in the current scan are not cured immediately after being deposited on the medium. Rather, they are smoothened and are cured by ultraviolet irradiation in the next scans. Therefore, the recorded image can be glossy. Furthermore, since it is not required to change the moving direction of the carriage or the medium, the recordation of the image is more efficient.

The print method may further include the step of curing the clear ink recorded on the medium in the next scan by turning on a third light source irradiating on a third band corresponding to a path area in an upstream region in the sub-scanning direction. It is preferred that a light intensity of one of the second and third light sources which is located in a more downstream region is less than a light intensity of the other light source. By doing so, the intensity of the initial irradiation on the clear ink is low, and the intensity of the irradiation on the clear ink is gradually increased in next scans. Therefore, the clear ink can be cured without any image banding due to rapid curing of the clear ink. Furthermore, when the clear ultraviolet-curable ink is recorded on a lower layer of other ultraviolet-curable ink, the adhesivity between two layers is greatly enhanced because the curing speed of the color ink is slower.

### Advantageous Effects

According to the present embodiments, glossy images can be recorded.

### BRIEF DESCRIPTION OF THE DRAWINGS

FIG. 1 illustrates an inkjet recording apparatus according to an embodiment of the present disclosure;

FIG. 2 is an enlarged view of the carriage shown in FIG. 1;

FIG. 3 is a perspective view of an ultraviolet irradiator with partition walls provided therein;

FIG. 4 is a perspective view of an ultraviolet irradiator without partition walls provided therein;

FIG. 5 is a cross-sectional view of the ultraviolet irradiator taken along line V-V shown in FIG. 2;

FIG. 6 is a cross-sectional view of the ultraviolet irradiator taken along line VI-VI shown in FIG. 2;

FIG. 7 illustrates an irradiating direction of ultraviolet rays where partition walls are provided between all UVLEDs;

FIG. 8 is a cross-sectional view of the ultraviolet irradiator where three partition walls are provided at equally-distanced positions;

FIG. 9 is a diagram showing a relationship between the ultraviolet irradiator and inkjet heads;

FIG. 10 is a flow chart of a printing process method in matt image mode;

FIG. 11 is a conceptual diagram showing an example of operation of the carriage in matt image mode;

FIG. 12 is a flow chart of a printing process method in gloss image mode;

FIG. 13(A) and FIG. 13(B) are conceptual diagrams showing examples of operation of the carriage in gloss image mode;

FIG. 14(A) and FIG. 14(B) show examples of light control of UVLEDs;

FIG. 15(A) to FIG. 15(C) illustrate states of ink droplets deposited on a medium;

FIG. 16 is a flow chart of a printing process method in single layer gloss image mode;

FIG. 17 is a conceptual diagram showing an example of operation of the carriage in single layer gloss image mode;

FIG. 18 is a flow chart of a printing process method in thick image mode;

FIG. 19(A) to FIG. 19(C) are conceptual diagrams showing examples of operation of the carriage in thick image mode;

FIG. 20 illustrates an ultraviolet irradiator with 7 partition walls provided therein;

FIG. 21 is a cross-sectional view of an ultraviolet irradiator in a sub-scanning direction where partition walls are removably insertable from a main body to a concave portion;

FIG. 22 shows an example of light control of UVLEDs in image recording process in gloss image mode; and

FIG. 23(A) and FIG. 23(B) illustrate ultraviolet irradiators according to other embodiments of the present disclosure.

### BEST MODE FOR CARRYING OUT THE INVENTION

Reference will now be made in detail to the preferred embodiments of the present disclosure, examples of which are illustrated in the accompanying drawings. Wherever possible, the same reference numbers will be used throughout the drawings to refer to the same or like parts. An inkjet recording apparatus 1 according to an embodiment of the present disclosure is an inkjet printer that uses ultraviolet-curable ink (hereinafter, “UV ink”) to print an image on a medium by using a multi-path recording method in which each image band is recorded by a plurality of paths.

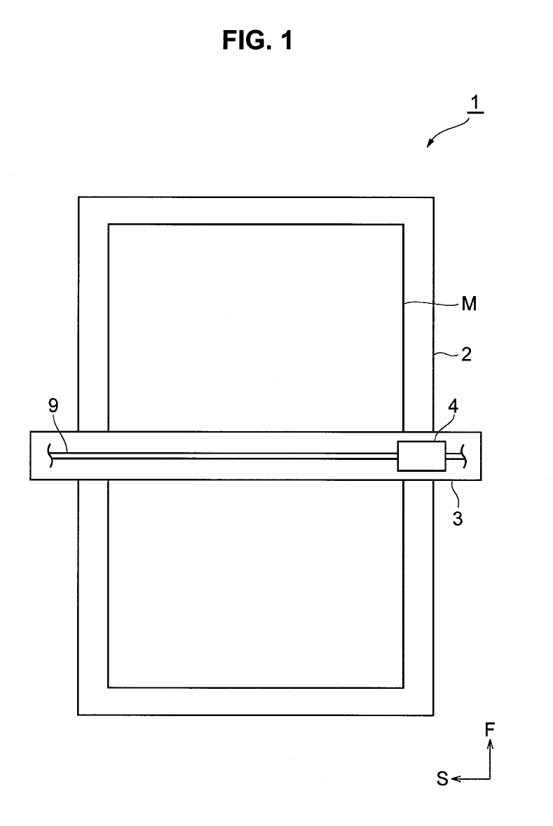

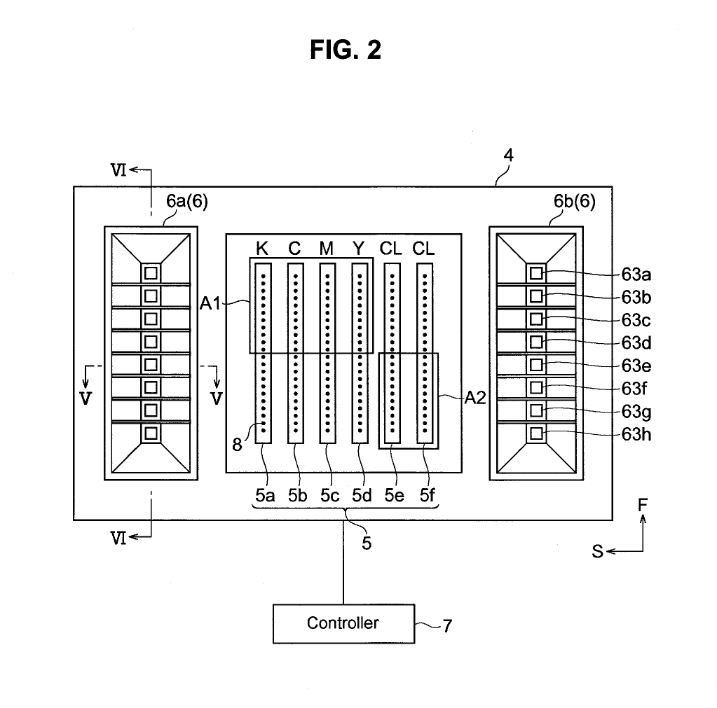

FIG. 1 illustrates the inkjet apparatus 1 according to the embodiment of the present disclosure, and FIG. 2 illustrates a carriage 4 shown in FIG. 1. Referring to FIGS. 1 and 2, the inkjet recording apparatus 1 includes a flat bed 2 on which a recording medium (M) is placed, a Y bar 3 which moves back and forth in a sub-scanning direction (F) over the flat bed 2, and the carriage 4 which is mounted on the Y bar 3 and moves back and forth in a main scanning direction (S). The recording apparatus 1 further includes a plurality of inkjet heads 5 (5a to 5f) mounted on the carriage 4 for discharging ink droplets, a pair of ultraviolet irradiators 6 (6a and 6b) mounted on the carriage 4 and positioned in the forward (left in FIG. 2) and backward (right in FIG. 2) regions in the main scanning direction (S) with respect to the inkjet heads 5 as shown in FIG. 2, and a controller 7 which controls the overall operation of the inkjet recording apparatus 1. The main scanning direction (S) is a direction in which the carriage 4 moves to record images bands on the recording medium. The sub-scanning direction (F) is a direction in which the Y bar 3 moves with respect to the medium in order to change locations of the image bands being recorded on the medium. The Y bar 3 carries the carriage 4 in the sub-scanning direction (F) for each predetermined path width and the carriage 4 moves back and forth in the main scanning direction (S) under the control of the controller 7 to record an image on the medium. During the recordation, the inkjet heads 5 discharge the ultraviolet-curable ink on the medium and the pair of ultraviolet irradiators 6 irradiate ultraviolet rays on the discharged ink. When the carriage 4 moves “forward” in the main scanning direction (S), it moves in the main scanning direction (S) (toward left in FIG. 1). When the carriage 4 moves “backward” in the main scanning direction (S), it moves in a direction opposite to the main scanning direction (S) (toward right in FIG. 1). In addition, when the Y 3 bar moves “forward” in the sub-scanning direction (F), it moves in the sub-scanning direction (F) (toward up in FIG. 1). When the Y bar 3 moves “backward” in the sub-scanning direction (F), it moves in a direction opposite to the sub-scanning direction (F) (toward down in FIG. 1).

The Y bar 3 carries the carriage 4 in the sub-scanning direction (F) with respect to the flat bed 2. For example, the Y bar 3 can be moveably mounted on a guide rail (not illustrated) extended in the sub-scanning direction (F) and can be coupled with a driving device such as a driving motor (not illustrated) to move back and forth in the sub-scanning direction (F). When the Y bar 3 moves forward in the sub-scanning direction (F), it moves from an upstream region (lower region in FIG. 1) to a downstream region (upper region in FIG. 1). In other words, the region from which it moves is called an upstream region and the region to which it moves is called a downstream region. Similarly, when the Y bar 3 moves backward in the sub-scanning direction (F), it also moves from an upstream region (upper region in FIG. 1) to a downstream region (lower region in FIG. 1). In other words, the region from which it moves is called an upstream region and the region to which it moves is called a downstream region.

The carriage 4 carries the inkjet heads 5 and the ultraviolet irradiators 6 in the main scanning direction (S) with respect to the flat bed 2. For example, the carriage 4 can be movably mounted on a guide rail 9 extended in the main scanning direction (S) as shown in FIG. 1 and can be coupled with a driving device such as a driving motor (not illustrated) such that it can move back and forth in the main scanning direction (S). When the carriage 4 moves forward in the main scanning direction (S), it moves from an upstream region to a downstream region. In other words, the region from which it moves is called an upstream region and the region to which it moves is called a downstream region. Similarly, when the carriage 4 moves backward in the main scanning direction (S), it moves from an upstream region to a downstream region. Similarly, the region from which it moves is called an upstream region and the region to which it moves is called a downstream region.

Referring to FIG. 2, the inkjet heads 5a-5f are aligned in the sub-scanning direction (F). The inkjet heads 5a, 5b, 5c, 5d, 5e and 5f are sequentially arranged in the order shown in FIG. 2. Since the inkjet heads 5 are mounted on the carriage 4, the inkjets heads 5 are able to discharge the ultraviolet-curable ink while they move in the main scanning direction (S).

Each inkjet head 5 includes a plurality of ink nozzles 8 which discharge ultraviolet-curable ink droplets. They are aligned in a nozzle line which is parallel to the sub-scanning direction (F). Referring to FIG. 2, each nozzle 8 of the inkjet heads 5a, 5b, 5c, and 5d located in the forward region (front region) in the main scanning direction (S) discharges color ultraviolet-curable ink (color ink). On the other hand, each nozzle 8 of the inkjet heads 5e and 5f located in the backward region (rear region) discharges clear ultraviolet-curable ink (clear ink). More particularly, each ink nozzle 8 of the inkjet heads 5a, 5b, 5c, and 5d discharges black (K), cyan (C), magenta (M), and yellow (Y) color inks, respectively. Each ink nozzle 8 of the inkjet heads 5e and 5f discharges clear ink (CL).

Only the ink nozzles of the inkjet heads 5a-5d located in a first discharge area A1 (forward region in the sub-scanning direction) discharge the color ink, and no color ink is discharged from other ink nozzles of the inkjet heads 5a-5d located in the backward region in the sub-scanning direction (F). Similarly, only the ink nozzles of the inkjet heads 5e and 5f located in a second discharge area A2 (backward region in the sub-scanning direction) discharge the clear ink. No clear ink is discharged from other ink nozzles of the inkjet heads 5e and 5f located in the forward region in the sub-scanning direction (F). Therefore, when the Y bar 3 moves in the sub-scanning direction (F), the color ink droplets discharged from the first discharge area A1 are recorded first on the medium placed on the flat bed 2. Thereafter, the clear ink droplets discharged from the discharge area A2 are recorded on the surface (upper layer) of the color ink recorded.

The ultraviolet irradiator 6a is located in the forward region in the main scanning direction (S) with respect to the inkjet heads 5, and the ultraviolet irradiator 6b is located in the backward region in the main scanning direction (S) with respect to the inkjet heads 5. The ultraviolet irradiators 6a and 6b are identical, and they irradiate ultraviolet rays to the ultraviolet-curable ink recorded on the medium to cure the recorded ink. For that reason, each of the irradiators 6a and 6b will be simply referred to as an ultraviolet irradiator 6. Since the ultraviolet irradiator 6 is mounted on the carriage 4 as shown in FIG. 2, it is able to irradiate ultraviolet rays while it moves in the main scanning direction (S).

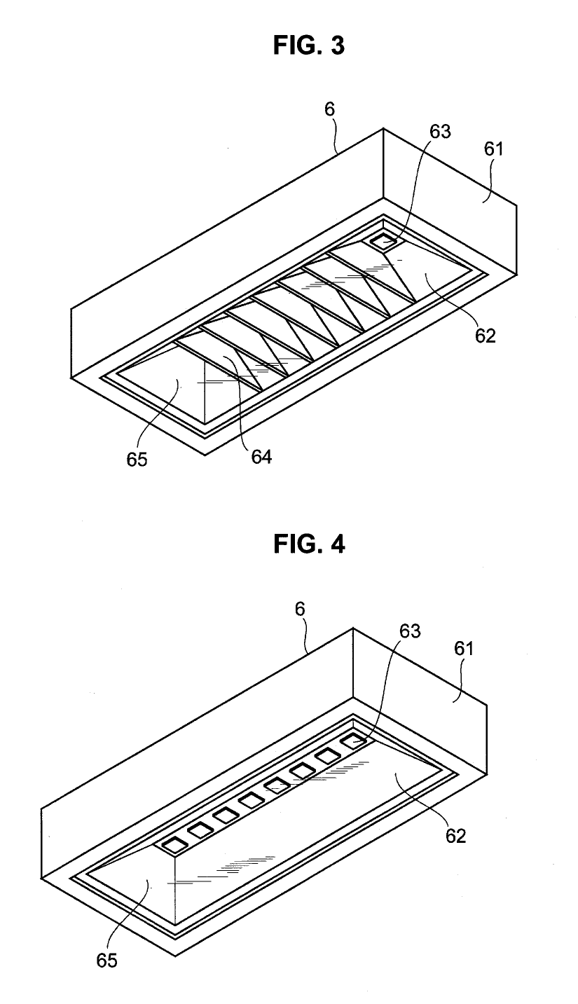

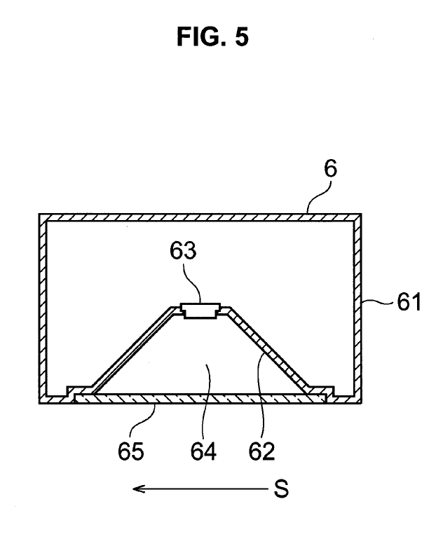

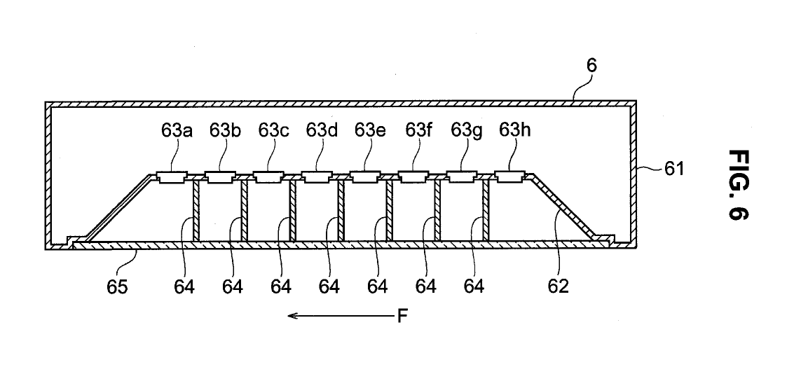

FIG. 3 is a perspective view of the ultraviolet irradiator 6 shown in FIG. 2 with partition walls 64, and FIG. 4 is a perspective view of the ultraviolet irradiator 6 shown in FIG. 2 without the partition walls 64. FIG. 5 is a cross-sectional view of the ultraviolet irradiator 6 taken along line V-V shown in FIG. 2, and FIG. 6 is a cross-sectional view of the ultraviolet irradiator 6 taken along line VI-VI shown in FIG. 2.

Referring to FIGS. 2 to 6, the ultraviolet irradiator 6 includes a main body 61, a concave portion 62 provided on the bottom side of the main body 61 facing the medium, a plurality of ultraviolet light emitting diodes (UVLEDs) 63 provided in the concave portion 62, and a plurality of partition walls 64 provided in the concave portion 62.

As shown in FIG. 5, the concave portion 62 reflects the ultraviolet rays emitted from the UVLEDs 63 vertically downward toward the flat bed 2 and is mirror-surfaced. The concave portion 62 has a long and thin trapezoidal shape in the sub-scanning direction (F). More particularly, the concave portion 62 is a quadrangular pyramid having a larger opening area and a smaller bottom area (top area shown in FIG. 5). It has an umbrella shape in which each inside surface is sloped at about 60 degrees with respect to a plane parallel to the flat bed 2 as shown in FIG. 5. For this reason, the cross section of the concave portion 62 in the main scanning direction (S) has a trapezoidal shape with a smaller width as shown in FIG. 5, and the cross section of the concave portion 62 in the sub-scanning direction (F) has a trapezoidal shape with a larger width as shown in FIG. 6.

A transparent cover 65 (e.g. quartz glass) having translucency is inserted perpendicularly to a rectangular opening formed on the top area of the concave portion 62. Thus, the opening area of the concave portion 62 is shielded and the ultraviolet rays irradiated from the UVLEDs 63 are penetrated.

Each UVLED 63 is positioned on a most concave area of the bottom area of the concave portion 62 and aligned equally distanced apart on one line in the sub-scanning direction (F). Each one of the plurality of the UVLEDs 63 is located in positions corresponding to the first discharge area A1 of the inkjet heads 5a-5d and the second discharge area A2 of the inkjet heads 5e and 5f in the main scanning direction (S).

However, for multi-path printing by the inkjet recording apparatus 1, each one of a plurality of bands can be recorded in ink droplets discharged in multi-paths in the first discharge area A1 and the second discharge area A2. Thus, the first discharge area A1 and the second discharge area A2 become a path area.

Therefore, according to an embodiment of the present disclosure, eight UVLEDs 63 are mounted to the ultraviolet irradiators 6 and four ULVEDs 63 are arranged in the main scanning direction to correspond to each of the first discharge area A1 and each of the second discharge area A2, respectively. In other words, the discharged ink droplets from the first discharge area A1 deposited on the medium (M) can be cured by UVLEDs 63a, 63b, 63c, and 63d. When the carriage 4 moves in the main scanning direction (S) and the ink droplets are discharged from the first discharge area A1 to record a band, the UVLEDs 63a, 63b, 63c, and 63d are located in positions such that the recorded band by the first discharge area A1 can be cured by irradiating ultraviolet rays. Also, the discharged ink droplets from the second discharge area A2 deposited on the medium (M) are cured by the UVLEDs 63e, 63f, 63g, and 63h. When the carriage 4 moves in the main scanning direction (S) and the ink droplets are discharged from the second discharge area A2 to record a band, the UVLEDs 63e, 63f, 63g, and 63h are located in positions such that the recorded band by the second discharge area A2 can be cured by irradiating ultraviolet rays. The UVLED 63a, the UVLED 63b, the UVLED 63c, and the UVLED 63d are sequentially arranged in the sub-scanning direction (F) as shown in FIG. 2. The UVLED 63e, the UVLED 63f, the UVLED 63g, and the UVLED 63h are sequentially arranged in the sub-scanning direction (F). Thus, for eight multi-path printing, one UVLED 63 corresponds to one band, for four multi-path printing, two UVLEDs 63 correspond to one band, and for two multi-path printing, four UVLEDs correspond to one band.

Meanwhile, since ultraviolet rays having a high directivity are irradiated from each UVLED 63, the intensity having a direction of 60° with respect to the vertical direction is 50% of the intensity in the vertical direction.

The partition wall 64 controls ultraviolet irradiation in the sub-scanning direction (F). It is positioned upright in the vertical direction and has a flat panel shape extended in the main scanning direction (S). The partition wall 64 has a trapezoidal shape having substantially same sizes with the cross sectional area of the concave portion 62 in the main scanning direction (S). Also, it is attached to the inner surfaces of the concave portion 62 and has a shape that extends from the bottom area of the concave portion 62 to its opening area. Thus, a shielded portion is formed by inserting the partition wall 64 in the concave portion 62 because there is no gap between the partition wall 64 and the concave portion 62, and ultraviolet rays cannot be leaked. The partition wall 64 preferably extends as closely as possible to the opening area of the concave portion 62 to an extent that the cover 65 can be inserted without difficulty on the opening area of the concave portion 62. For example, the size of the partition wall 64 can be such that there is no gap between the partition wall 64 and the cover 65 inserted on the opening area.

Such partition wall 64 is positioned in between the neighboring UVLEDs 63 and mounted such that it can be individually inserted and removed for the ultraviolet irradiators 6. Thus, a maximum of seven partition walls 64 can be inserted in the ultraviolet irradiators 6 having the eight UVLEDs 63 (refer to FIG. 3) and all the partition walls 64 can be removed (refer to FIG. 4).

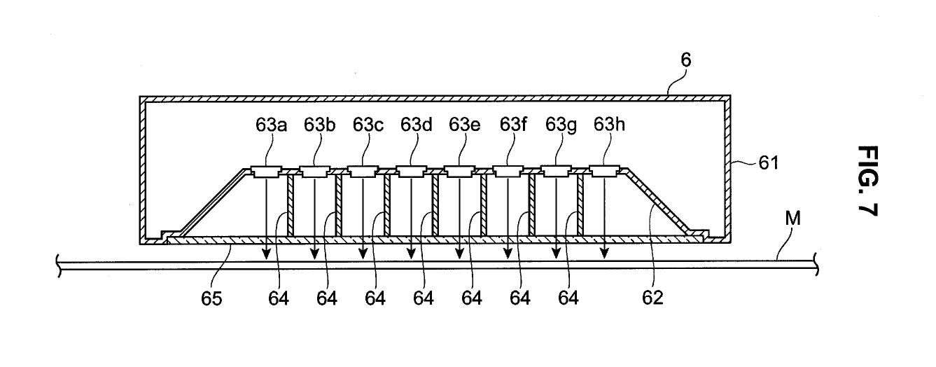

FIG. 7 illustrates an irradiating direction of ultraviolet rays when the partition walls are inserted in between all the UVLEDs. As shown in FIG. 7, if the partition walls 64 are inserted in between all the UVLEDs 63, ultraviolet rays irradiated from each UVLED 63 are emitted only to a vertically downward region of each UVLED 63 in the sub-scanning direction (F) and are prevented from being emitted to vertically downward regions of the neighboring UVLEDs 63 in the sub-scanning direction (F). Thus, ultraviolet rays are irradiated to a portion of the medium (M) only from one of the UVLEDs 63 positioned vertically above the portion and ultraviolet rays are not irradiated from the neighboring UVLEDs 63.

The controller 7 controls the Y bar 3, the carriage 4, the inkjet head 5, and the ultraviolet irradiators 6 to record images on the medium (M) placed on the flat bed 2. Thus, the controller 7 generates matte, glossy or thick images. A mode generating matte images is referred to as a matte image mode, and a mode generating glossy images is referred to as a gloss image mode. A mode recording clear ink only (without generating image) is referred to as a single layer gloss image mode and a mode generating thick images is referred to as a thick image mode. For example, the controller 7 can be implemented by a computer including CPU, ROM, and RAM and each control of the controller 7 can be realized by enabling the computer to read and execute computer-readable program codes recorded on the CPU or RAM.

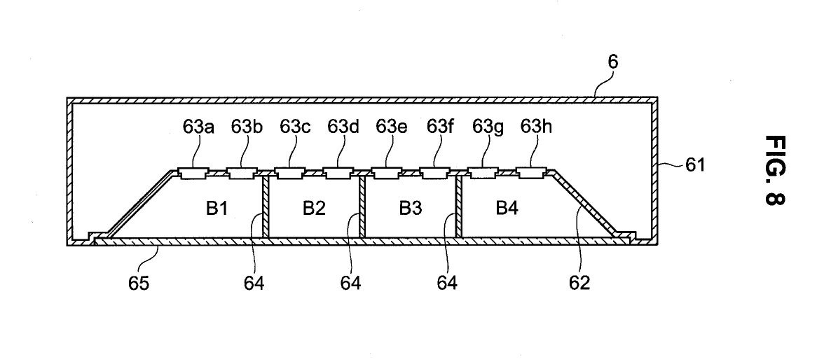

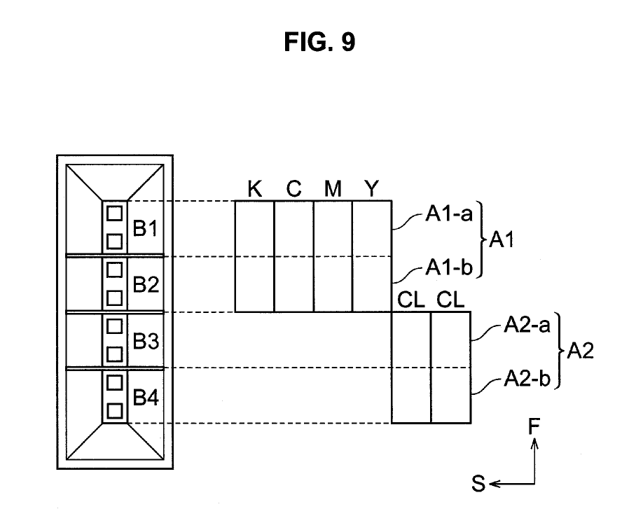

A printing method by using the inkjet recording apparatus 1 will now be described. As shown in FIG. 8, three partition walls 64 are inserted equally distanced apart into the ultraviolet irradiators 6. A four multi-path printing is performed where two path color ink image recordation is made and two path clear ink image recordation is made. Thus, each of the first and the second discharge areas A1 and A2 in FIG. 2 records two bands. For convenience of explanation as shown in FIG. 9, the forward region of the first discharge area A1 in the sub-scanning direction (F) is referred as “the first discharge area A1-a ” and the backward region of the first discharge area A1 in the sub-scanning direction (F) is referred as “the first discharge area A1-b ”. The forward region of the second discharge area A2 in the sub-scanning direction (F) is referred as “the second discharge area A2-a ” and the backward region of the second discharge area A2 in the sub-scanning direction (F) is referred as “the second discharge area A2-b”.

The concave portion 62 is divided into four areas by each partition wall 64. The UVLED 63a and the UVLED 63b are positioned in area B1, the UVLED 63c and the UVLED 63d are positioned in area B2, the UVLED 63e and the UVLED 63f are positioned in area B3, and the UVLED 63g and the UVLED 63h are positioned in area B4. Thus, as shown in FIG. 9, the area B1 corresponds to one band of the first discharge area A1-a, the area B2 corresponds to one band of the first discharge area A1-b, the area B3 corresponds to one band of the second discharge area A2-a, and the area B4 corresponds to one band of the second discharge area A2-b. In other words, the ink droplets discharged from the first discharge area A1-a deposited on the medium (M) are irradiated from the UVLEDs 63a and 63b, the ink droplets discharged from the first discharge area A1-b deposited on the medium (M) are irradiated from the UVLEDs 63c and 63d, the ink droplets discharged from the second discharge area A2-a deposited on the medium (M) are irradiated from the UVLEDs 63e and 63f, and the ink droplets discharged from the second discharge area A2-b deposited on the medium (M) are irradiated from the UVLEDs 63g and 63h. Thus, when the first discharge area A1 discharges ink droplets to record a band while the carriage 4 moves in the main scanning direction (S), the UVLEDs 63a and 63b of the area B1 are positioned in a position in which the band recorded from the first discharge area A1-a can be cured by irradiating ultraviolet rays. The UVLEDs 63c and 63d of the area B2 are positioned in a position in which the band recorded from the first discharge area A1-b can be cured by irradiating ultraviolet rays. The UVLEDs 63e and 63f of the area B3 are positioned in a position in which the band recorded from the second discharge area A2-a can be cured by irradiating ultraviolet rays. Finally, the UVLEDs 63g and 63h of the area B4 are positioned in a position in which the band recorded from the second discharge area A2-b can be cured by irradiating ultraviolet rays.

The controller 7 controls a printing operation of the inkjet recording apparatus 1 as shown in FIG. 2. In other words, in the controller 7, a processing unit (not shown) including a CPU controls the Y bar 3, the carriage 4, the inkjet heads 5, the ultraviolet irradiators 6 according to a program recorded in a memory device such as a ROM.

[Matte Image Mode]

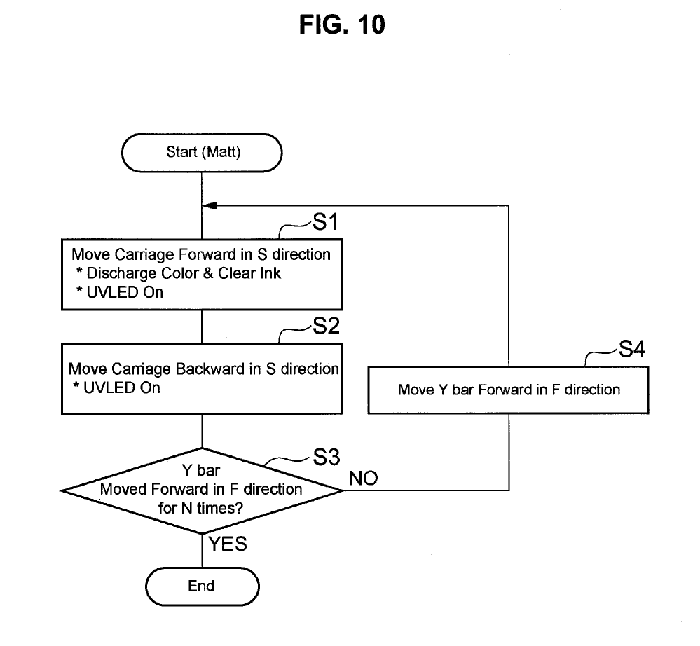

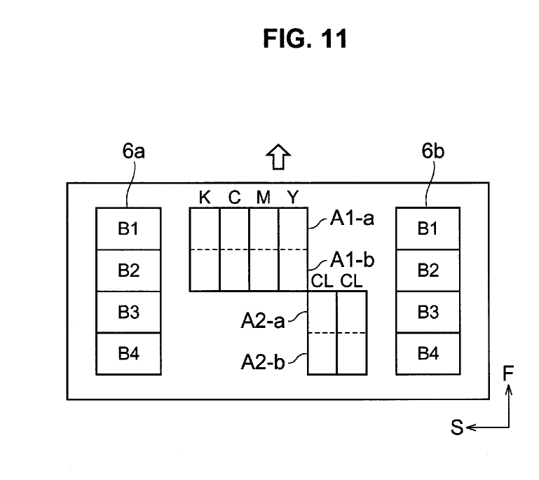

Referring to FIGS. 10 and 11, a printing process method for the matte image mode will be now described. FIG. 10 is a flow chart of the printing process method in the matte image mode. FIG. 11 is a conceptual diagram showing an operation of the carriage 4 in the matte image mode. As shown in FIG. 11, the Y bar 3 moves in the sub-scanning direction (F). In the matte image mode, ultraviolet-curable ink is discharged only when the carriage 4 moves forward in the main scanning direction (S) and no ink is discharged when the carriage 4 moves backward in the main scanning direction (S)

In the matte image mode, the medium (M) is first placed on the flat bed 2 and the Y bar 3 is located on a backward region (print starting position) in the sub-scanning direction (F) of a recording area of the medium (M).

As shown in FIG. 11, in a first scan, the first discharge area A1-a discharges color ink droplets and simultaneously the UVLEDs 63a and 63b positioned in the area B1 of the ultraviolet irradiator 6b are turned on when the carriage 4 moves forward in the main scanning direction (S) (step S1). Also, the UVLED 63 irradiating ultraviolet rays on the band recorded in the step S1 is turned on when the carriage 4 moves backward in the main scanning direction (S) (step S2). The UVLEDs 63 of at least one of the ultraviolet irradiators 6a and 6b may be turned on when the carriage 4 moves backward in the main scanning direction (S). Then, a first path record is made by the color ink discharged from the first discharge area A1-a and this color ink is cured in a particle shape by irradiating ultraviolet rays after being deposited on the medium (M).

When the back-and-forth motion of the carriage 4 in the main scanning direction (S) is completed, whether the Y bar 3 has moved in the sub-scanning direction (F) for a predetermined number of times is determined (step S3). In the matte image mode, a plurality of divided bands of printing data are recorded while the Y bar 3 sequentially moves in the sub-scanning direction (F). Recording each band is completed in four scans because two path record is made on the band by color ink in the first two scans and two path record is made on the band by clear ink in the next two scans. Thus, it is determined in the step S3 that the Y bar 3 has moved in the sub-scanning direction (F) for the predetermined number of times after the fourth scan and the predetermined number of times is calculated by adding a number of the plurality of the divided bands and three.

Since this scan is the first scan, it is determined that the Y bar 3 has not moved in the sub-scanning direction (F) for the predetermined number of times (step S3: No). Then, the step S1 is repeated after moving the Y bar 3 by one band (path width) in the sub-scanning direction (F) (step S4). Since the carriage 4 mounted on the Y bar 3 is moved by one band in the sub-scanning direction (F), the inkjet heads 5 and the ultraviolet irradiators 6 correspond to the next path line and a recording position with respect to the medium (M) moves forward in the sub-scanning direction (F).

In the second scan, when the carriage 4 moves forward in the main scanning direction (S), color ink droplets are discharged from the first discharge area A1-a and the UVLEDs 63a and 63b positioned in the area B1 of the ultraviolet irradiator 6b are turned on. Furthermore, color ink droplets are discharged from the first discharge area A1-b and the UVLEDs 63c and 63d positioned in the area B2 of the ultraviolet irradiator 6b are turned on (step S1). When the carriage 4 moves backward in the main scanning direction (S), the UVLEDs 63 irradiating ultraviolet rays on the band recorded in the step S1 is turned on (step S2). However, the UVLEDs 63 of at least one of the ultraviolet irradiators 6a and 6b may be turned on when the carriage 4 moves backward in the main scanning direction (S). Then, the second path record is made by the color ink discharged from the first discharge area A1-b on the band on which the first path record is made by the color ink discharged from the first discharge area A1-a during the first scan. The color ink is cured in a particle shape by irradiating ultraviolet rays after being deposited on the medium (M). Now, the image recording by color ink on the band is completed. In the second scan, the first path record is made by the color ink discharged from the first discharge area A1-a (similar to first scan).

After the back-and-forth motion of the carriage 4 moving in the main scanning direction (S) is completed, the Y bar 3 is moved by one band (path width) in the sub-scanning direction (F) (step S4) and the step S1 is repeated because this scan is the second scan (step S3: No). Since the carriage 4 mounted on the Y bar 3 is moved by one band in the sub-scanning direction (F), the inkjet heads 5 and the ultraviolet irradiators 6 correspond to the next path line and a recording position with respect to the medium (M) moves forward in the sub-scanning direction (F).

In the third scan, when the carriage 4 moves forward in the main scanning direction (S), color ink droplets are discharged from the first discharge areas A1-a and A1-b and the UVLEDs 63a-63d positioned in the areas B1 and B2 of the ultraviolet irradiator 6b are turned on. Furthermore, the second discharge area A2-a discharges clear ink droplets and the UVLEDs 63e and 63f positioned in the area B3 of the ultraviolet irradiator 6b are turned on (step S1). When the carriage 4 moves backward in the main scanning direction (S), the UVLEDs 63 irradiating ultraviolet rays on the band recorded in the step S1 is turned on (step S2). However, when the carriage 4 moves backward in the main scanning direction (S), the UVLEDs 63 of at least one of the ultraviolet irradiators 6a and 6b can be turned on. Then, the third path record is made by the clear ink discharged from the second discharge area A2-a on the band on which the second path record is made by the color ink discharged from the first discharge area A1-b during the second scan. This clear ink is cured in a particle shape by irradiating ultraviolet rays after being deposited on the medium (M). Thus, a first layer of coating is placed on the images of the medium (M) by the clear ink. In the third scan, the first path record is made by the color ink discharged from the first discharge area A1-a (similar to first scan). The second path record is made by the color ink discharged from the first discharge area A1-b (similar to second scan).

After the back-and-forth motion of the carriage 4 moving in the main scanning direction (S) is completed, the Y bar 3 is moved by one band (path width) in the sub-scanning direction (F) (step S4) and the step S1 is repeated because this scan is the third scan (step S3: No). Since the carriage 4 mounted on the Y bar 3 is moved by one band in the sub-scanning direction (F), the inkjet heads 5 and the ultraviolet irradiators 6 correspond to the next path line and a recording position with respect to the medium (M) moves forward in the sub-scanning direction (F).

In the fourth scan, when the carriage 4 moves forward in the main scanning direction (S), the first discharge areas A1-a and A1-b discharge color ink droplets and the UVLEDs 63a-63d positioned in the areas B1 and B2 of the ultraviolet irradiator 6b are turned on. The second discharge area A2-a discharges clear ink droplets and the UVLEDs 63e and 63f positioned in the area B3 of the ultraviolet irradiator 6b are turned on. Furthermore, the second discharge area A2-b discharges clear ink droplets and simultaneously the UVLEDs 63g and 63h positioned in the area B4 of the ultraviolet irradiator 6b are turned on (step S1). When the carriage 4 moves backward in the main scanning direction (S), the UVLEDs 63 irradiating ultraviolet rays on the band recorded in the step S1 is turned on (step S2). However, when the carriage 4 moves backward in the main scanning direction (S), the UVLEDs 63 of at least one of the ultraviolet irradiators 6a and 6b can be turned on. Then, the fourth path record is made by the clear ink discharged from the second discharge area A2-b on the band on which the third path record is made by the clear ink discharged from the second discharge area A2-a during the previous scan. This clear ink is cured in a particle shape by irradiating ultraviolet rays after being deposited on the medium (M). Thus, a second layer of coating is placed on the images of the medium (M) by the clear ink and all the recordings for the band (discharging ultraviolet-curable ink, curing ultraviolet-curable ink by ultraviolet irradiator) are completed. In this fourth scan, the first path record is made by the color ink discharged from the first discharge area A1-a (similar to first scan). The second path record is made by the color ink discharged from the first discharge area A1-b (similar to second scan), and the third path record is made by the clear ink discharged from the second discharge area A2-a (similar to third scan).

After the back-and-forth motion of the carriage 4 moving in the main scanning direction (S) is completed, whether the Y bar 3 has moved in the sub-scanning direction (F) for the predetermined number of times is determined because this scan is the fourth scan (step S3).

If the Y bar 3 has not moved in the sub-scanning direction for the predetermined number of times (step 3: No), the Y bar 3 is moved by one band (path width) in the sub-scanning direction (F) (step S4) and the step S1 is repeated. Since the carriage 4 mounted on the Y bar 3 is moved by one band in the sub-scanning direction (F), the inkjet heads 5 and the ultraviolet irradiators 6 correspond to the next path line and a recording position with respect to the medium (M) moves forward in the sub-scanning direction (F). The steps S1 to S3 are repeated until it is determined in the step S3 that the Y bar 3 has moved in the sub-scanning direction (F) for the predetermined number of times.

However, if it is determined that the Y bar 3 has moved in the sub-scanning direction (F) for the predetermined number of times (step S3: Yes), the printing process in the matte image mode is completed.

Since the clear ink having an uneven surface is recorded as an upper layer on the image recorded on the medium (M), the visibility of the image is enhanced and the matte image can be recorded.

[Gloss Image Mode]

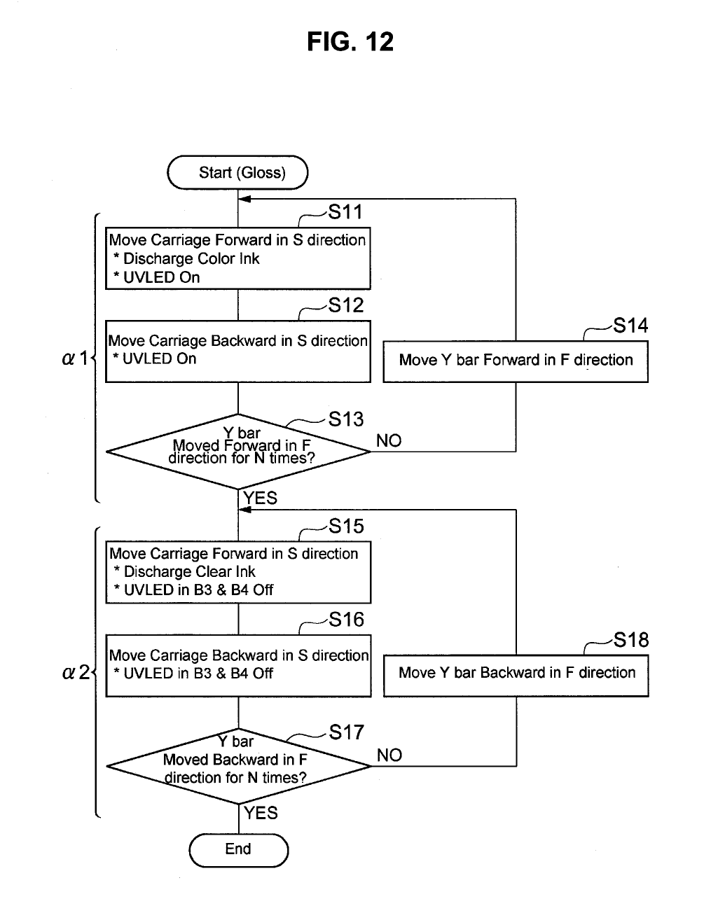

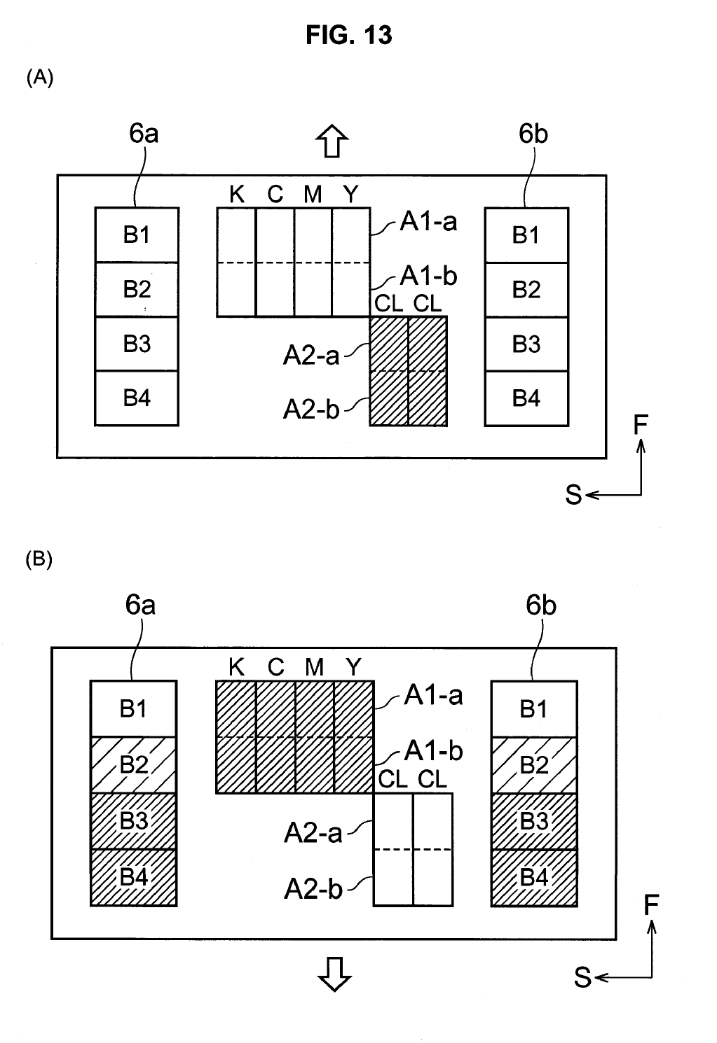

Referring to FIGS. 12 and 13, a printing process method in the gloss image mode will be now described. FIG. 12 is a flow chart of the printing process method in gloss image mode. FIGS. 13(A) and (B) illustrate conceptual diagrams of an operation of the carriage 4 in the gloss image mode. In FIG. 13, the Y bar 3 moves in the sub-scanning direction (F). In other words, FIG. 13(A) illustrates that the Y bar 3 moves forward in the sub-scanning direction (F) and FIG. 13(B) illustrates that the Y bar 3 moves backward in the sub-scanning direction (F). In the gloss image mode, ultraviolet-curable ink is discharged only when the carriage 4 moves forward in the main scanning direction (S) and the ultraviolet-curable ink is not discharged when the carriage 4 moves backward in the direction of the main scanning direction (S).

As shown in FIGS. 12 and 13, in the gloss image mode, an image is recorded in color ink by sequentially moving the Y bar 3 in the sub-scanning direction (F) in the steps S11 to S14, and the image is coated with clear ink by sequentially moving the Y bar 3 backward in the sub-scanning direction (F) in the steps S15 to S18. In other words, in the color image mode, the image is recorded in color ink when the Y bar 3 moves forward in the sub-scanning direction (F), and the image is coated with clear ink when the Y bar 3 moves backward in the sub-scanning direction (F). Thus, the steps S11 to S14 are referred to as an image recording process (α1) and an example of an operation of the carriage 4 in this image recording process is shown in FIG. 13(A). Also, the steps S15 to S18 are referred to as a coating process (α2) and an example of an operation of the carriage 4 in this coating process is shown in FIG. 13(B).

The printing process method of the gloss image mode will now be described in detail.

First, the medium (M) is placed on the flat bed 2 and the Y bar 3 is positioned in the backward region (print starting position) in the sub-scanning direction (F) in a recording area of the medium (M). The image recording process (α1) is made by sequentially moving the Y bar 3 in the sub-scanning direction (F).

As shown in FIG. 13(A), in the first scan of the image recording process (al), the first discharge area A1-a discharges color ink droplets and the UVLEDs 63a and 63b positioned in the area B1 of the ultraviolet irradiator 6b are turned on when the carriage 4 moves forward in the main scanning direction (S) (step S11). Also, the UVLEDs 63 irradiating ultraviolet rays to the recorded band in the step S1 are turned on when the carriage 4 moves backward in the main scanning direction (S) (step S12). However, when the carriage 4 moves backward in the main scanning direction (S), the UVLEDs 63 corresponding to at least one of the ultraviolet irradiators 6a and 6b can be turned on. Then, the first path record is made by the color ink discharged from the first discharge area A1-a and this color ink is cured in a particle shape by irradiating ultraviolet rays after being deposited on the medium (M).

After the back-and-forth motion of the carriage 4 in the main scanning direction (S) is completed, it is determined whether the Y bar 3 has moved in the sub-scanning direction (F) for a predetermined number of times (step S13). A plurality of divided bands for printing data are recorded while the Y bar 3 sequentially moves in the sub-scanning direction (F). Two path color ink recordation and irradiation are made in the first two scans and two path irradiation is made to complete four scan (four path) recordation for each band. Thus, it is determined that the Y bar 3 has moved in the sub-scanning direction (F) for the predetermined number of times in the step S13 after the fourth scan and the predetermined number of times is calculated by adding a number of the divided printing data and three.

Since this scan is the first scan of the image recording process (α1), it is determined that the Y bar 3 has not moved in the sub-scanning direction (F) for the predetermined number of times (step S13: No). Then, the step S11 is repeated after moving the Y bar by one band (path width) in the sub-scanning direction (F) (step S14). Since the carriage 4 mounted on the Y bar 3 is moved by one band in the sub-scanning direction (F), the inkjet heads 5 and the ultraviolet irradiators 6 correspond to the next path line, and a recording position with respect to the medium (M) moves forward in the sub-scanning direction (F).

In the second scan of the image recording process (α1), when the carriage 4 moves forward in the main scanning direction (S), the first discharge area A1-a discharges color ink droplets and the UVLEDs 63a and 63b positioned in the area B1 of the ultraviolet irradiator 6b are turned on. Furthermore, the first discharge area A1-b discharges color ink droplets and the UVLEDs 63c and 63d positioned in the area B2 of the ultraviolet irradiator 6b are turned on (step S11). When the carriage 4 moves backward in the main scanning direction (S), the UVLEDs 63 irradiating ultraviolet rays on the band recorded in the step Sll are turned on (step S12). However, when the carriage 4 moves backward in the main scanning direction (S), the UVLEDs 63 corresponding to at least one of the ultraviolet irradiators 6a and 6b is turned on. Then, the second path record is made by the color ink discharged from the first discharge area A1-b on the band on which the first path record is made by the color ink discharged from the first discharge area A1-a during the previous scan. The color ink is cured in a particle shape by irradiating ultraviolet rays after being deposited on the medium (M). Now, the image recording on the band by the color ink is completed. In the second scan, the first path record is made by the color ink discharged from the first discharge area A1-a (similar to the first scan).

The Y bar 3 is moved by one band (path width) in the sub-scanning direction (F) (step S14) and the step S11 is repeated because this scan is the second scan of the image recording process (α1) (step S13: No). Since the carriage 4 mounted on the Y bar 3 is moved by one band in the sub-scanning direction (F), the inkjet heads 5 and the ultraviolet irradiators 6 correspond to the next path line and a recording position with respect to the medium (M) moves forward in the sub-scanning direction (F).

In the third scan of the image recording process (α1), when the carriage 4 moves forward in the main scanning direction (S), the first discharge areas A1-a and A1-b discharge color ink droplets and the UVLEDs 63a to 63d positioned in the areas B1 and B2 of the ultraviolet irradiator 6b are turned on. Furthermore, the UVLEDs 63e and 63f positioned in the area B3 are turned on (step S11). When the carriage 4 moves backward in the main scanning direction (S), the UVLEDs 63 irradiating ultraviolet rays on the band recorded in the step S11 are turned on (step S12). The color ink recorded on the band is further cured because the third path is made by irradiating from the UVLEDs 63e and 63f positioned in the area B3 on the band on which the second path is made by the color ink discharged from the first discharge area A1-b during the previous scan. In the third scan, the first path record is made by the color ink discharged from the first discharge area A1-a (similar to first scan) and the second path is made by the color ink discharged from the first discharge area A1-b (similar to second scan).

Since this scan is the third scan of the image recording process (α1), it is determined that the Y bar 3 has not moved for a predetermined number (m) of times (step S13: No). The Y bar 3 is moved by one band (path width) in the sub-scanning direction (F) and the step 11 is repeated (step S13: No). Since the carriage 4 mounted on the Y bar 3 is moved by one band in the sub-scanning direction (F), the inkjet heads 5 and the ultraviolet irradiators 6 correspond to the next path line and a recording position with respect to the medium (M) moves forward in the sub-scanning direction (F).

In the fourth scan of the image recording process (α1), when the carriage 4 moves forward in the main scanning direction (S), the first discharge areas A1-a and A1-b discharge color ink droplets and the UVLEDs 63a-63d positioned in the areas B1 and B2 of the ultraviolet irradiator 6b are turned on. The UVLEDs 63e and 63f positioned in the area B3 of the ultraviolet irradiator 6b are turned on. Furthermore, the UVLEDs 63g and 63h positioned in the area B4 of the ultraviolet irradiator 6b are turned on (step S11). When the carriage 4 moves backward in the main scanning direction (S), the UVLEDs 63 irradiating ultraviolet rays on the band recorded in the step 11 and the UVLED 63e to 63h positioned in the areas B3 and B4 are turned on (step S12). The color ink recorded on the band is further cured because the band irradiated by the UVLEDs 63e and 63f positioned in the area B3 in the previous scan is irradiated from the UVLEDs 63g and 63h positioned in the area B4 correspond to the fourth path. In this fourth scan, the first path record is made by color ink discharged from the first discharge area A1-a (similar to first scan), the second path record is made by the color ink discharged from the first discharge area A1-b (similar to second scan), and the band on which the second path is made is irradiated from the UVLEDs 63e and 63f positioned in the area B4 (similar to third scan).

After the back-and-forth motion of the carriage 4 moving in the main scanning direction (S) is completed, whether the Y bar 3 has moved in the sub-scanning direction (F) for the predetermined number of times is determined because this scan is the fourth scan of the image recording process (α1) (step S13).

If the Y bar 3 has not moved in the sub-scanning direction (F) for the predetermined number of times (step S13: No), the Y bar 3 is moved by one band (path width) in the sub-scanning direction (F) (step S14) and the step Sll is repeated. Since the carriage 4 mounted on the Y bar 3 is moved by one band in the sub-scanning direction (F), the inkjet heads 5 and the ultraviolet irradiators 6 correspond to the next path line and a recording position with respect to the medium (M) moves forward in the sub-scanning direction (F). The steps S11 to S13 are repeated until it is determined in the step S13 that the Y bar 3 has moved for the predetermined number of times.

Here, a method of recording the final band by the image recording process (α1) will be now described, when the final scan is the (m)th scan.

In the (m-2)th scan which is two scans before the final scan, when the carriage 4 moves forward in the main scanning direction (S), the color ink discharged from the first discharge area A1-a stops discharging color ink. The first discharge area A1-b discharges color ink droplets, the UVLEDs 63c and 63d positioned in the area B2 of the ultraviolet irradiator 6b, the UVLEDs 63e-63h positioned in the areas B3 and B4 are turned off (step S11). When the carriage 4 moves backward in the main scanning direction (S), the UVLEDs 63 irradiating ultraviolet rays to the carriage 4 and the UVLEDs 63e-63h positioned in the areas B3 and B4 are turned on (step S12). Then, the second path record is made by the color ink discharged from the first discharge area A1-a on the final band on which the first path record is made by the color ink discharged from the first discharge area A1-a during the previous scan. The UVLEDs 63e and 63f positioned in the area B3 irradiates ultraviolet rays on the band on which the second path is made by the color ink discharged from the first discharge area A1-b. The UVLEDs 63g-63h positioned in the area B4 irradiates ultraviolet rays on the band irradiated by ultraviolet rays from the UVLEDs 63e and 63f positioned in the area B3.

In the (m-1)th scan which is one scan before the final scan, when the carriage 4 moves forward in the main scanning direction (S), the first discharge areas A1-a and A1-b stop discharging the color ink and the UVLEDs 63e-63h positioned in the areas B3 and B4 are turned on (step S11). When the carriage 4 moves backward in the main scanning direction (S), the UVLEDs 63e-63h positioned in the areas B3 and B4 are turned on (step S12). Then, the UVLEDs 63e and 63f positioned in the area B3 irradiate ultraviolet rays on the final band on which the second path is made by the color ink discharged from the first discharge area A1-b during the previous scan. The UVLEDs 63g and 63h positioned in the area B4 irradiate ultraviolet rays on the band irradiated by ultraviolet rays from the UVLEDs 63e and 63f positioned in the area B3 during the previous scan.

In the final (m)th scan, when the carriage 4 moves forward in the main scanning direction (S), the first discharge areas A1-a and A1-b stop discharging the color ink. The UVLEDs 63e and 63f positioned in the area B3 are turned off and the UVLEDs 63g and 63h are turned on (step S11). When the carriage 4 moves backward in the main scanning direction (S), only the UVLEDs 63g and 63h positioned in the area B4 are turned on (step S12). Then, the UVLEDs 63g and 63h positioned in the area B4 irradiate ultraviolet rays on the final band irradiated by ultraviolet rays from the UVLEDs 63e and 63f positioned in the area B3 during the previous scan.

Thus, the image recording process (α1) is terminated while the second discharge area A2-b is positioned on the path line of the final band.

Meanwhile, if it is determined that the Y bar 3 has moved forward in the sub-scanning direction (F) for the predetermined number of times (step S13: Yes), the coating process (α2) is made by sequentially moving the Y bar 3 backward in the sub-scanning direction (F).

As shown in FIG. 13(B), in the first scan of the coating process (α2), when the carriage 4 moves forward in the main scanning direction (S), the second discharge area A2-b discharges clear ink droplets and the UVLEDs 63g and 63h positioned in the ultraviolet irradiators 6a and 6b of the area B4 are turned off (step S15). Also, when the carriage 4 moves backward in the main scanning direction (S), the UVLEDs 63g and 63h positioned on the band recorded by the clear ink in the step S15 are turned off (step S16). The second discharge area A2-b is positioned on the path line of the final band in the image recording process (α1). Thus, the fifth path record is made by the clear ink discharged from the second discharge area A2-b on the final band of the image recording process (α1) positioned in the most forward region in the sub-scanning direction (F). Since the UVLEDs 63g and 63h positioned in the area B4 irradiating ultraviolet rays on the band recorded by clear ink discharged from the second discharge area A2-b are turned off, clear ink discharged on the medium (M) during the fifth path is not cured but spread out. Then, its thickness becomes thinner and the embossed surface becomes flattened. Meanwhile, in the first scan, the UVLEDs 63a-63d positioned in the areas B1 and B2 can be turned on or off.

When the back-and-forth motion of the carriage 4 moving in the main scanning direction (S) is completed, whether the Y bar 3 has moved in the sub-scanning direction (F) for a predetermined number of times is determined (step S17). In the coating process (α2), a plurality of a divided band for printing data is recorded while the Y bar 3 sequentially moves in the sub-scanning direction (F). Recording each band is completed in four scans (four paths) because the band is recorded by clear ink in the first two scans and the recorded clear ink in each band is irradiated by ultraviolet rays in the next two scans. Thus, it is determined that the Y bar 3 has moved backward in the sub-scanning direction (F) for the predetermined number of times in the step S17 after the fourth scan and the predetermined number of times is calculated by adding a number of the divided printing data and three.

It is determined that the Y bar 3 has not moved backward in the sub-scanning direction (F) for the predetermined number of times (step S17: No) because this scan is the first scan of the coating process (α2). The step S15 is repeated after moving the Y bar 3 backward by one band (path width) in the sub-scanning direction (F) (step S18). Since the Y bar 3 mounted to the carriage 4 is moved backward by one band in the sub-scanning direction (F), the inkjet heads 5 and the ultraviolet irradiators 6 correspond to the next path line and a recording position with respect to the medium (M) moves backward in the sub-scanning direction (F).

In the second scan of the coating process (α2), when the carriage 4 moves forward in the main scanning direction (S), the second discharge area A2-b discharges clear ink droplets and the UVLEDs 63g and 63h positioned in the area B4 of the ultraviolet irradiators 6b and 6b are turned off. Furthermore, the second discharge area A2-a discharges clear ink droplets and the UVLEDs 63e and 63f positioned in the area B3 of the ultraviolet irradiators 6a and 6b are turned off (step S15). When the carriage 4 moves backward in the main scanning direction (S), the UVLEDs 63e-63h aligned on the band recorded in clear ink in the step S15 are turned off (step S16). The sixth path record is made by the clear ink discharged from the second discharge area A2-a on the band on which the fifth path record is made by the clear ink discharged from the second discharge area A2-b during the first scan. Since the UVLEDs 63e and 63f positioned in the area B3 irradiating ultraviolet rays on the band recorded by the clear ink discharged from the second discharge area A2-a are turned off, the clear ink discharged on the medium (M) in the sixth path is not cured but gradually spread out with the clear ink in the fifth path. Its thickness becomes thinner and the embossed surface becomes flattened. Also, in this second scan, the fifth path record is made by the clear ink discharged from the second discharge area A2-b (similar to first scan). Meanwhile, the UVLEDs 63a-63d positioned in the areas B1 and B2 can be turned on or off.

After the back-and-forth motion of the carriage 4 in the main scanning direction (S) is completed, the Y bar 3 is moved backward by one band (path width) in the sub-scanning direction (step S17: No) and the step S15 is repeated because this scan is the second scan of the coating process (α2) (step 18). Since the carriage 4 mounted on the Y bar 3 is moved backward by one band in the sub-scanning direction (F), the inkjet heads 5 and the ultraviolet irradiators 6 correspond to the next path line and a recording position with respect to the medium (M) moves backward in the sub-scanning direction (F).

In the third scan of the coating process (α2), when the carriage 4 moves forward in the main scanning direction (S), the second discharge areas A2-a and A2-b discharge clear ink droplets, the UVLEDs 63e to 63h positioned in the ultraviolet irradiators 6a and 6b of the areas B3 and B4 are turned off, the UVLEDs 63c and 63d positioned in the area B2 is turned on (step S15). When the carriage 4 moves backward in the main scanning direction (S), the UVLEDs 63c and 63d positioned in the area B2 are turned on (step S16). At least one of the ultraviolet irradiators 6a and 6b turns on the UVLEDs 63c and 63d. The seventh path is made by ultraviolet rays irradiated from the UVLEDs 63c and 63d positioned in the area B2 on the band on which the sixth path record is made by the clear ink discharged from the second discharge area A2-a during the second scan. Curing starts when the clear ink from the fifth and sixth paths becomes sufficiently flatten. In the third scan, the fifth path record is made by the clear ink discharged from the second discharge area A2-b (similar to first scan) and the sixth path record is made by the clear ink discharged from the second discharge area A2-a (similar to second scan).

After the back-and-forth motion of the carriage 4 in the main scanning direction (S) is completed, the Y bar 3 is moved backward by one band (path width) in the sub-scanning direction (step S18) and the step S15 is repeated, since this scan is the third scan of the coating process (α2) (step S17: No). Since the carriage 4 mounted on the Y bar 3 is moved backward by one band in the sub-scanning direction (F), the inkjet heads 5 and the ultraviolet irradiators 6 correspond to the next path line and a recording position with respect to the medium (M) moves backward in the sub-scanning direction (F).

In the fourth scan of the coating process (α2), when the carriage 4 moves forward in the main scanning direction (S), the second discharge areas A2-a and A2-b discharge clear ink droplets, the UVLEDs 63e-63h positioned in the areas B3 and B4 of the ultraviolet irradiators 6a and 6b are turned off, and the UVLEDs 63a and 63b positioned in the area B1 are turned on (step S15). Also, when the carriage moves backward in the main scanning direction (S), the UVLEDs 63a-63d positioned in the areas B1 and B2 are turned on (step S16). At least one of the ultraviolet irradiators 6a and 6b turns on the UVLEDs 63a-63d. The eighth path is made by ultraviolet rays irradiated from the UVLEDs 63a and 63b positioned in the area B1 on the band irradiated by ultraviolet rays from the UVLEDs 63c and 63d during the third scan and curing clear ink is sufficiently enhanced. In the fourth scan, the fifth path record is made by the clear ink discharged from the second discharge area A2-b (similar to first scan), and the sixth path record is made by the clear ink discharged from the second discharge ink A2-a (similar to second scan). The band on which the sixth path record is made in the previous scan is irradiated by ultraviolet rays.

When the back-and-forth motion of the carriage 4 in the main scanning direction (S) is terminated, since this scan is the fourth scan of the coating process (α2), it is determined whether the Y bar 3 moves backward in the sub-main scanning direction (F) for the predetermined number of times (step S17).

If it is determined that the Y bar 3 has not moved backward in the sub-scanning direction (F) for the predetermined number of times (step S17: No), the Y bar 3 moves backward in the sub-scanning direction (F) by one band (path width) (step S18) and the step S15 is repeated. Since the carriage 4 mounted on the Y bar 3 is moved backward by one band in the sub-scanning direction (F), the inkjet heads 5 and the ultraviolet irradiators 6 correspond to the next path line and a recording position with respect to the medium (M) moves backward in the sub-scanning direction (F). The steps of S15 to S17 are repeated until it is determined in the step S17 that the Y bar 3 has moved backward in the sub-scanning direction (F) for the predetermined number of times.

If it is determined that the Y bar 3 has moved backward in the sub-scanning direction (F) for the predetermined number of times (step S17: Yes), the printing process in the gloss image mode is terminated.

Since the smoothened clear ink is recorded as an upper layer on the image recorded on the medium (M), the image visibility is enhanced and the image becomes glossy.

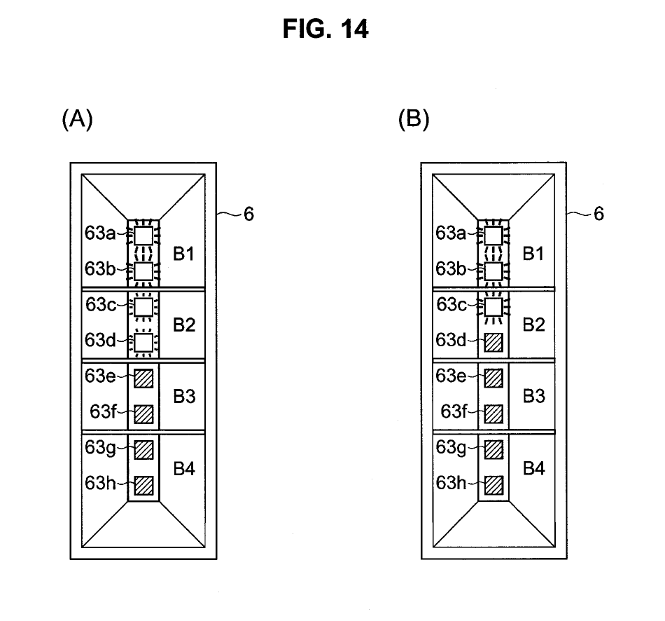

In the steps S15 and S16, it is preferred that the amount of the ultraviolet irradiation emitted from the UVLEDs 63c and 63d positioned in the area B2 is less than that of the UVLEDs 63a and 63b positioned in the area B1. The amount of ultraviolet irradiation can be controlled by individual light control of the UVLEDs 63. As shown in FIG. 14(A), the amount of the ultraviolet irradiation of the UVLEDs 63c and 63d is reduced by lowering the current flowing through the UVLEDs 63c and 63d. As shown in FIG. 14(B), the UVLED 63c can be turned on like the UVLEDs 63a and 63b and the UVLED 63d can be turned off. Meanwhile, for highly curable ink, only UVLEDs 63a and 63b can be turned on.

Since the amount of initial ultraviolet irradiation is reduced and the amount of the ultraviolet irradiation can be gradually increased, bending caused by curing clear ink quickly can be prevented and the clear ink can be surely cured by turning on the UVLEDs 63. Since the speed of curing the clear ink directly deposited on the color ink slows down, the adherence of the color ink and the clear ink improves.

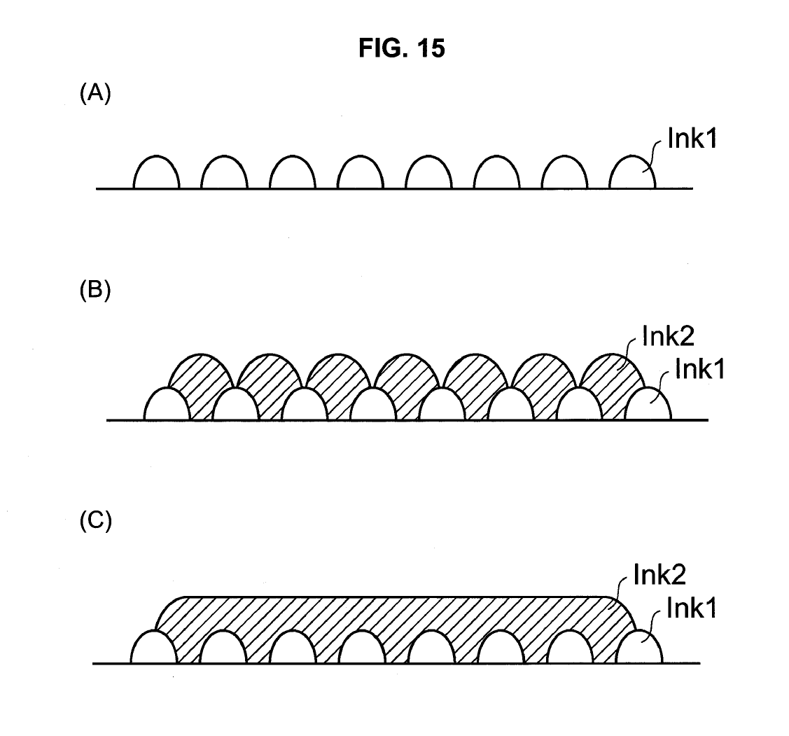

Referring to FIGS. 15(A) to (C), a curing status of the clear ink will now be described. FIGS. 15(A) to (C) illustrate ink droplets deposited on the medium (M). In the image recording process (α1), since color ink (Ink 1) is cured in a particle shape after being deposited on the medium (M), the color ink (ink 1) is cured in a particle shape as shown in FIG. 15(A). In the coating process (α2), since clear ink (Ink 2) is not cured after being deposited on the medium (M), the clear ink (ink 2) is smeared into the cured color ink (ink 1), and is combined with the neighboring clear ink (ink 2) droplets. The clear ink (ink2) smoothens the uneven surface because it spreads out and its thickness is reduced. If a lower layer of the color ink is smoothened, the speed of smoothening the clear ink slows down because the motion of the clear ink on the upper layer is not active. Thus, the speed of smoothening the clear ink increases by curing the color ink on the lower layer in a particle shape because the motion of the upper layer of the clear ink becomes active. Since the clear ink (ink 2) is cured after it is sufficiently smoothened, the gloss quality of the images can be obtained.

[Single Layer Gloss Image Mode]

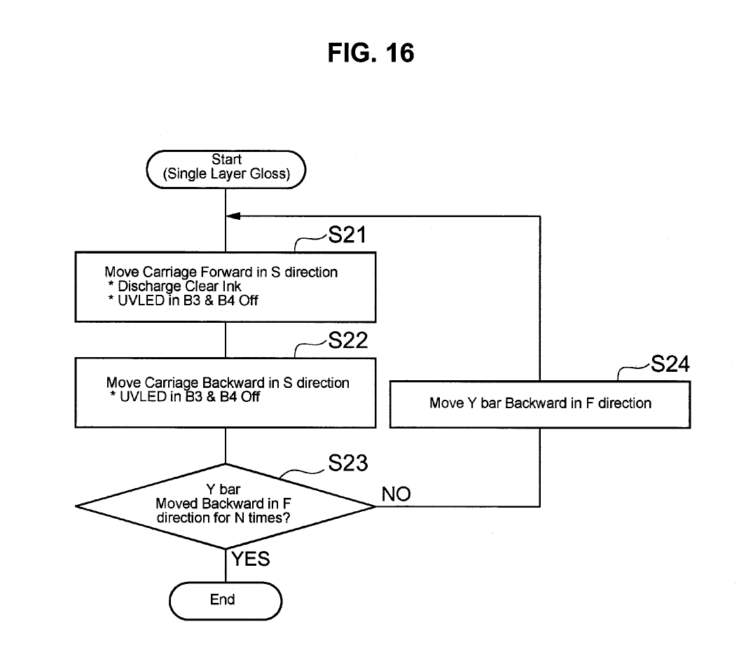

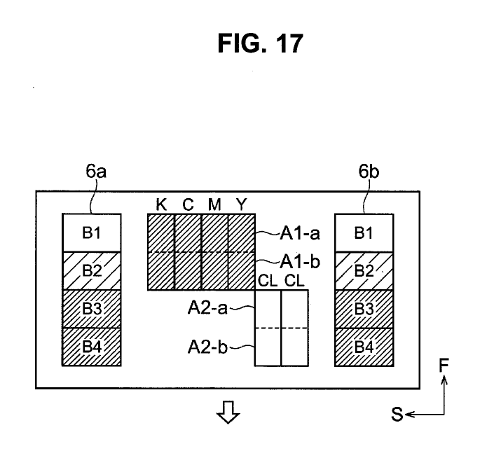

Reference will now be made to in detail to a print control method in a single layer gloss image mode with reference to FIGS. 16 and 17. FIG. 16 is a flowchart of the print control method in the single layer gloss image mode. FIG. 17 is a conceptual diagram showing an example of operation of the carriage 4 in the single layer gloss image mode. As shown in FIG. 17, the Y bar 3 and the carriage 4 move backward in the sub-scanning direction (F). In the single layer gloss image mode, the ultraviolet-curable ink is discharged only when the carriage 4 moves forward in the main scanning direction (S). In other words, the ink is not discharged when the carriage 4 moves backward in the main scanning direction (S).

Referring to FIGS. 16 and 17, since only clear ink (for glossiness) is recorded while the Y bar 3 moves backward in the sub-scanning direction (F) in the single layer gloss image mode, the medium on which an image is recorded is placed on the flat bed 2 first, and then the Y bar 3 is positioned in the forward region (print start position) of a recording area of the medium in the sub-scanning direction (F).

Referring to FIG. 17, in the first scan of the single layer gloss image mode, the second discharging area (A2-b) discharges clear ink droplets and the UVLEDs (63g and 63h) positioned in the area B4 of the ultraviolet irradiators 6a and 6b are simultaneously turned off (step S21) while the carriage 4 moves forward in the main scanning direction (S). In addition, the UVLEDs 63g and 63h corresponding to the clear ink band recorded in the step S21 are turned off while the carriage 4 moves backward in the main scanning direction (S) (step S22). Then, the first path record is made on the most forward image band in the sub-scanning direction (F) by the clear ink discharged from the second discharging area A2-b. Since the UVLEDs 63g and 63h positioned in the area B4 which irradiate ultraviolet rays on the clear ink band discharged from the second discharging area A2-b are turned off, the first path clear ink deposited on the medium is not cured immediately but is rather gradually spread out. Therefore, the surface thickness is reduced and the surface texture is smoothened. In the first scan, the UVLEDs (63a to 63d) positioned in the areas B1 and B2 may or may not be turned off.

When the back-and-forth movement of the carriage 4 in the main scanning direction (S) is completed, it is determined in the step S23 whether the Y bar 3 has moved backward in the sub-scanning direction (F) for a predetermined number of times (step S23). In the single layer gloss image mode, a plurality of divided bands of print data are recorded by sequentially moving the Y bar 3 backward in the sub-scanning direction (F). And, two path recordation of the clear ink is made for each band during the first two scans, and the ultraviolet rays are irradiated to each clear ink band during the next two scans. Therefore, the recordation of each band is completed with four scans (four paths). For this reason, the determination that the Y bar 3 has moved backward in the sub-scanning direction (F) for the predetermined number of times in the step S23 can be made after the fourth scan, and the predetermined number of times is calculated by adding 3 to a total number of divisions of the print data.

Since it was the first scan of the single layer gloss image mode, it is determined in the step 23 that the Y bar 3 has not moved backward in the sub-scanning direction (F) for the predetermined number of times (No in step S23), and the Y bar 3 moves backward in the sub-scanning direction (F) for a single band (path width) (step S24). Thereafter, it returns to the step S21. Since the carrier 4 also moves backward in the sub-scanning direction (F) for a single band in the step S24, the inkjet heads 5 and the ultraviolet irradiators 6 now correspond to the next path line and the recording location on the medium moves backward in the sub-scanning direction (F).

In the second scan of the single layer gloss image mode, the second discharging area A2-b discharges clear ink droplets and the UVLEDs (63g and 63h) positioned in the area B4 of the ultraviolet irradiators 6a and 6b are simultaneously turned off while the carriage 4 moves forward in the main scanning direction (S). Simultaneously, the second discharging area A2-a discharges clear ink droplets and the UVLEDs (63e and 63f) positioned in the area B3 of the ultraviolet irradiators 6a and 6b are also turned off (step S21). Thereafter, the UVLEDs 63e to 63h corresponding to the clear ink band recorded in the step S21 are turned off while the carriage 4 moves backward in the main scanning direction (S) (step S22). Then, the second path record is further made with the clear ink discharged from the second discharging area A2-a to the band to which the first path record is made with the clear ink discharged from the second discharging area A2-b during the first scan. Since the UVLEDs 63e and 63f positioned in the discharging area B3 which irradiate ultraviolet rays to the clear ink band discharged from the second discharging area A2-a are turned off, the second path clear ink is not cured immediately but is rather gradually spread out together with the first path clear ink. Therefore, the surface thickness is reduced and the surface texture is smoothened. In the second scan, the first path record is made by the clear ink discharged from the second discharging area A2-b (similar to first scan). In the second scan, the UVLEDs (63) positioned in the areas B1 and B2 may or may not be turned off.

When the back-and-forth movement of the carriage 4 in the main scanning direction (S) is completed, it is determined in the step S23 that the Y bar 3 has not moved backward in the sub-scanning direction (F) for the predetermined number of times because it is the second scan of the single layer gloss image mode (No in step S23). Thereafter, the Y bar 3 moves backward in the sub-scanning direction (F) for a single band (path width) (step S24), and it returns to the step S21. Since the carrier 4 also moves backward in the sub-scanning direction (F) for a single band in the step S24, the inkjet heads 5 and the ultraviolet irradiators 6 now correspond to the next path line and the recording location on the medium moves backward in the sub-scanning direction (F).

In the third scan of the single layer gloss image mode, the second discharging areas A2-a and A2-b discharge clear ink droplets while the carriage 4 moves forward in the main scanning direction (S) (step S21). At the same time, the UVLEDs 63e to 63h positioned in the areas B3 and B4 of the ultraviolet irradiators 6a and 6b are turned off, and the UVLEDs 63c and 63d positioned in the area B2 are turned on. Thereafter, the UVLEDs 63c and 63d positioned in the area B2 are turned on while the carriage 4 moves backward in the main scanning direction (S) (step S22). The UVLEDs 63c and 63d being turned on may be of at least one of the ultraviolet irradiators 6a and 6b. The UVLEDs 63c and 63d positioned in the area B2 irradiate ultraviolet rays as a third path on the band on which the second path record is made by the clear ink discharged from the second discharging area A2-a during the second scan, and the first and second clear ink start to cure after being sufficiently smoothened. In the third scan, the first path record is made by the clear ink discharged from the second discharging area A2-b (similar to first scan) and the second path record is made by the clear ink discharged from the second discharging area A2-a (similar to second scan)

When the back-and-forth movement of the carriage 4 in the main scanning direction (S) is completed, it is determined in the step S23 that the Y bar 3 has not moved backward in the sub-scanning direction (F) for the predetermined number of times because it is the third scan of the single layer gloss image mode (No in step S23). Thereafter, the Y bar 3 moves backward in the sub-scanning direction (F) for a single band (path width) (step S24), and it returns to the step S21. Since the carrier 4 also moves backward in the sub-scanning direction (F) for a single band in the step S24, the inkjet head 5 and the ultraviolet irradiator 6 now correspond to the next path line and the recording location on the medium moves backward in the sub-scanning direction (F).

In the fourth scan of the single layer gloss image mode, the second discharging areas A2-a and A2-b discharge ink droplets while the carriage 4 moves forward in the main scanning direction (S) (step S21). At the same time, the UVLEDs 63e to 63h positioned in the areas B3 and B4 of the ultraviolet irradiators 6a and 6b are turned off, the UVLEDs 63c and 63d positioned in the area B2 are turned on, and the UVLEDs 63a and 63b positioned in the area B1 are turned on. Thereafter, the UVLEDs 63a to 63d positioned in areas B1 and B2 are turned on while the carriage 4 moves backward in the main scanning direction (S) (step S22). The UVLEDs 63a to 63d being turned on may be of at least one of the ultraviolet irradiators 6a and 6b. Then, the UVLEDs 63a and 63b positioned in the area B1 irradiate ultraviolet rays as a fourth path on the band on which the UVLEDs 63c and 63d positioned in the area B2 have previously irradiated during the third scan, and the clear ink can be sufficiently cured. In the fourth scan, the first path record is made by the clear ink discharged from the second discharging area A2-b (similar to first scan), the second path record is made by the clear ink discharged from the second discharging area A2-a (similar first scan), and the ultraviolet rays are irradiated on the band on which the second path record is made (similar to third scan).

When the back-and-forth movement of the carriage 4 in the main scanning direction (S) is completed, it is determined in the step S23 whether the Y bar 3 has moved backward in the sub-scanning direction (F) for the predetermined number of times.

If it is determined that the Y bar 3 has not yet moved for the predetermined number of times (No in step S23), the Y bar 3 moves backward in the sub-scanning direction (F) for a single band (path width) (step S24) and it returns to the step S21. Since the carriage 4 also moves backward in the sub-scanning direction (F) for a single band in the step S24, the inkjet 5 and the ultraviolet irradiator 6 now correspond to the next path line and the recording location of the medium moves backward in the sub-scanning direction (F). The steps S21 to S23 are repeated until it is determined in the step S23 that the Y bar 3 has moved backward in the sub-scanning direction (F) for the predetermined number of times.

When it is finally determined in the step S23 that the Y bar 3 has moved for the predetermined number of times (Yes in step S23), the print process in the single layer gloss image mode is terminated.

Since the smoothened clear ink is recorded on the medium on which the image is recorded, the visibility and glossiness of the image are enhanced.

[Thick Image Mode]

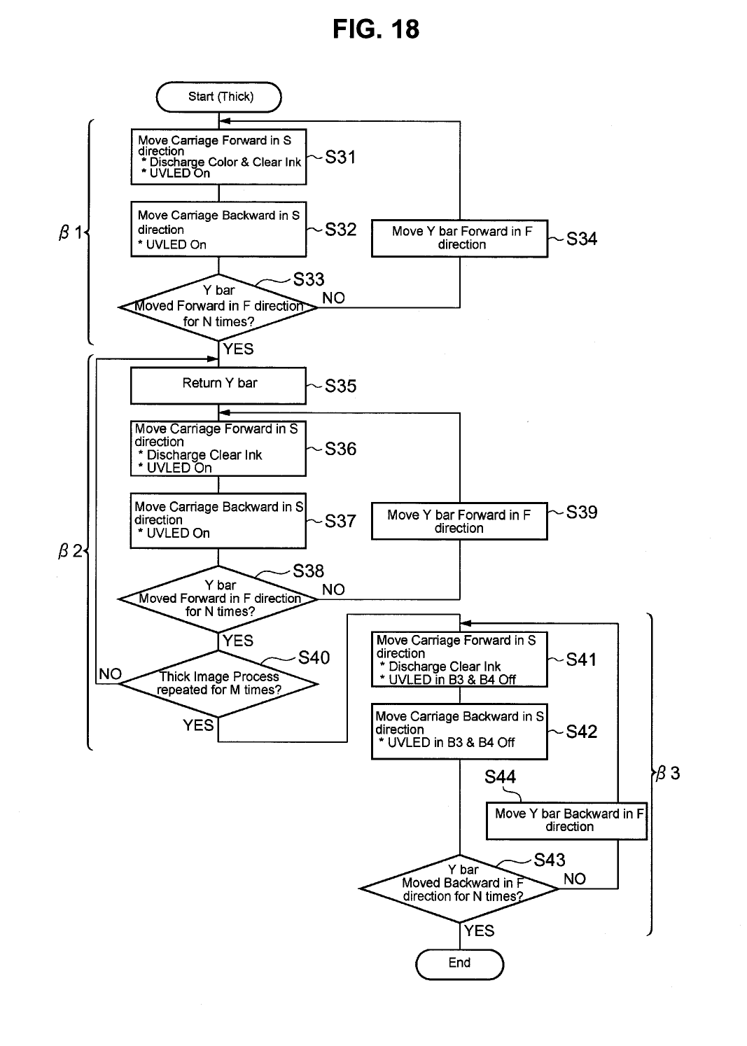

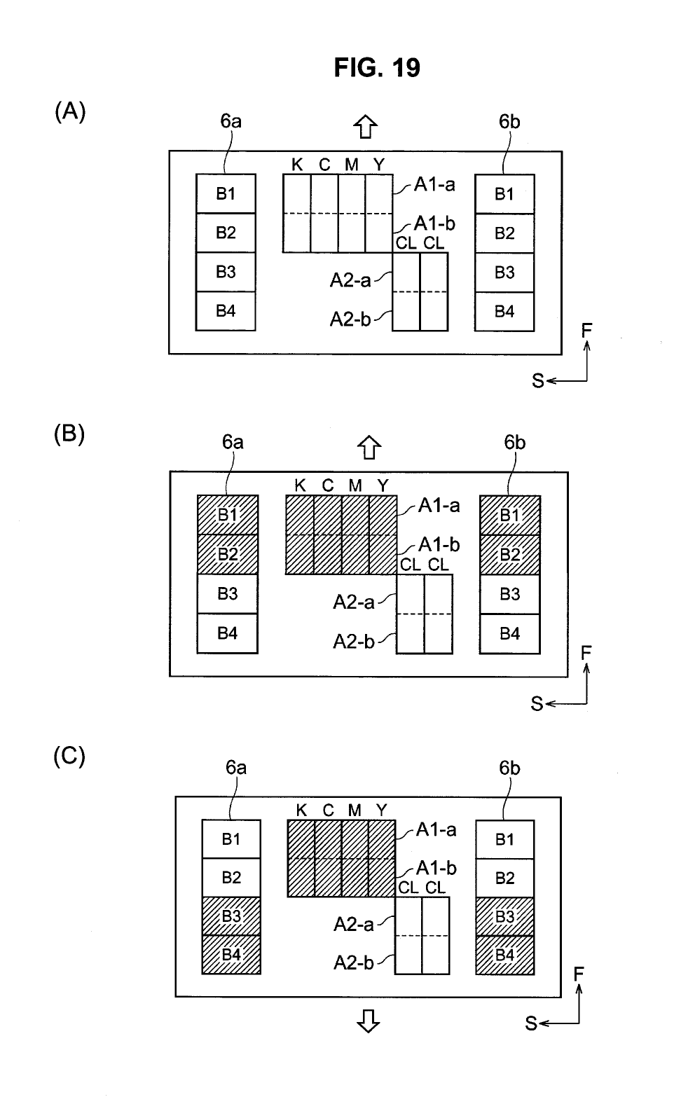

Referring to FIGS. 18 and 19(A) to (C), a printing process method in the thick image mode will now be described. FIG. 18 is a flow chart of the printing process method in the thick image mode. FIGS. 19(A) to (C) illustrates a conceptual diagram of an operation of the carriage 4 in the thick image mode. In FIGS. 19(A) to (C), the Y bar 3 moves in the sub-scanning direction (F). In other words, the Y bar 3 moves in the sub-scanning direction (F) in FIGS. 19(A) and (B) but the Y bar 3 moves backward in the sub-scanning direction (F) in FIG. 19(C). The ultraviolet-curable ink is discharged only when the carriage 4 moves in the main scanning direction (S) in the thick image mode. The ultraviolet curable ink is not discharged when the carriage 4 moves backward in the main scanning direction (S).

As shown in FIGS. 18 and 19(A) to (C), in the thick image mode, the image recording by color ink and image coating by clear ink are made by sequentially moving the Y bar 3 in the sub-scanning direction (F) in the steps S31 to S34. The image is thickened by clear ink by sequentially moving the Y bar 3 in the sub-scanning direction (F) in the steps S35 to S40. The gloss process by clear ink is made by moving the Y bar 3 backward in the sub-scanning direction (F) in the steps S41 to S44. Thus, the steps S31 to S34 are referred to as an image recording coating process (β1) and FIG. 19(A) shows an operation of the carriage 4 in the image recording coating process (β1). The steps S35 to S40 are referred to as a thick image process (β2) and FIG. 19(B) shows an operation of the carriage 4 in the thick image process (β2). Finally, the steps S41 to S44 are referred to as a gloss process (β3) and FIG. 19(C) shows an operation of the carriage 4 in the gloss process (β3).

The printing process method in the thick image mode will now be described in detail.

The medium (M) is placed on the flat bed 2, the Y bar 3 is located in the forward region (print starting position) in the sub-scanning direction (F) of a recording area of the medium (M), and the image recording coating process (β1) is moved by sequentially moving the Y bar 3 in the sub-scanning direction (F).

As shown in FIG. 19(A), in the first scan of the image recording coating process (β1), when the carriage 4 moves forward in the main scanning direction (S), the first discharge area A1-a discharges the color ink droplets and simultaneously the UVLEDs 63a and 63b positioned in the ultraviolet irradiator 6b of the area B1 are turned on (step S31). When the carriage 4 moves backward in the main scanning direction (S), the UVLEDs 63 irradiating ultraviolet rays on the band recorded in the step S31 are turned on (step S32). When the carriage 4 moves backward in the main scanning direction (S), the UVLEDs 63 of at least one of the ultraviolet irradiators 6a and 6b can be turned on. Then, a first path record is made by the color ink discharged from the first discharge area A1-a and the color ink is cured in a particle shape after being deposited on the medium (M).

After the back-and-forth motion of the carriage 4 in the main scanning direction (S) is completed, it is determined whether the Y bar 3 has moved in the sub-scanning direction (F) for a predetermined number of times (step S33). A plurality of divided bands for printing data are recorded by sequentially moving the Y bar 3 forward in the sub-scanning direction (F) in the image recording coating process (β1). The recordation for each band is completed in four scans because two path recordation by color ink is made on the band in the first two scans and two path recordation by clear ink is made on the band in the next two scans. Thus, it is determined that the Y bar 3 has moved in the sub-scanning direction (F) for the predetermined number of times after the fourth scan in the step S33 and the predetermined number of times is calculated by adding the number of the divided printing data and three.

Since this scan is the first scan of the image recording coating process (β1), it is determined that the Y bar 3 has not moved in the sub-scanning direction for the predetermined number of times (step S33: No). The Y bar 3 is moved by one band (path width) in the sub-scanning direction (F) (step S34) and the step S31 is repeated. Since the carriage 4 mounted on the Y bar 3 is moved by one band in the sub-scanning direction (F), the inkjet heads 5 and the ultraviolet irradiators 6 correspond to the next path line and a recording position with respect to the medium (M) moves forward in the sub-scanning direction (F).

In the second scan of the image recording coating process (β1), when the carriage 4 moves forward in the main scanning direction (S), the first discharge area A1-a discharges color ink droplets and simultaneously the UVLEDs 63a and 63b positioned in the ultraviolet irradiator 6b of the area B1 are turned on. Furthermore, the first discharge area A1-b discharges color ink droplets and simultaneously the UVLEDs 63c and 63d positioned in the ultraviolet irradiator 6b of the area B2 are turned on (step S31). When the carriage 4 moves backward in the main scanning direction (S), the UVLEDs 63 irradiating ultraviolet rays on the band recorded in the step S31 are turned on (step S32). When the carriage 4 moves backward in the main scanning direction (S), the UVLEDs of at least one of the ultraviolet irradiators 6a and 6b are turned on. Then, the second path record is made by the color ink discharged from the first discharge area A1-b on the band on which the first path is made by the color ink discharged from the first discharge area A1-a. This color ink is cured in a particle shape by irradiating ultraviolet rays after being deposited on the medium (M). Thus, all the recordings by color ink (discharging by color ink, curing color ink by ultraviolet irradiation) on the band are terminated. In the second scan, the first path record is made by the color ink discharged from the first discharge area A1-a (similar to first scan).

After the back-and-forth motion of the carriage 4 in the main scanning direction (S) is completed, since this scan is the second scan of the image recording coating process (β1) (step S33: No), the Y bar 3 is moved by one band (path width) in the sub-scanning direction (F) (step S34) and the step S31 is repeated. Since the carriage 4 mounted on the Y bar 3 is moved by one band in the sub-scanning direction (F), the inkjet heads 5 and the ultraviolet irradiators 6 correspond to the next path line and a recording position with respect to the medium (M) moves forward in the sub-scanning direction (F).

In the third scan of the image recording coating process (β1), when the carriage 4 moves in the main scanning direction (S), the first discharge areas A1-a and A1-b discharge color ink droplets and simultaneously the UVLEDs 63a-63d positioned in the ultraviolet irradiator 6b of the areas B1 and B2 are turned on. Furthermore, the second discharge area A2-a discharges clear ink droplets and simultaneously the UVLEDs 63e and 63f positioned in the ultraviolet irradiator 6b of the area B3 are turned on (step S31). When the carriage 4 moves backward in the main scanning direction (S), the UVLEDs 63 irradiating ultraviolet rays on the band recorded in the step S31 are turned on (step S32). When the carriage 4 moves backward in the main scanning direction (S), the UVLEDs 63 of at least one of the ultraviolet irradiators 6a and 6b are turned on. Then, the third path record is made by the color ink discharged from the second discharge area A2-a on the band on which the second path record is made by the color ink discharged from the first discharge area A1-b during the second scan. This clear ink is cured in a particle shape by irradiating ultraviolet rays after being deposited on the medium (M). Thus, a first layer of coating by clear ink on the images is generated. In the third scan, the first path record is made by the color ink discharged from the first discharge area A1-a (similar to first scan) and the second path record is made by the color ink discharged from the first discharge area A1-b (similar to second scan).

After the back-and-forth motion of the carriage 4 in the main scanning direction (S) is completed, since this scan is the third scan of the image recording coating process (β1) (step S33: No), the Y bar 3 is moved by one band (path width) in the sub-scanning direction (F) (step S34) and the step S31 is repeated. Since the carriage 4 mounted on the Y bar 3 is moved by one band in the sub-scanning direction (F), the inkjet heads 5 and the ultraviolet irradiators 6 correspond to the next path line and a recording position with respect to the medium (M) moves forward in the sub-scanning direction (F).

In the fourth scan of the image recording coating process (β1), when the carriage 4 moves in the main scanning direction (S), the first discharge areas A1-a and A1-b discharge color ink droplets and simultaneously the UVLEDs 63a-63d positioned in the ultraviolet irradiator 6b of the areas B1 and B2 are turned on. The second discharge area A2-a discharges clear ink droplets and simultaneously the UVLEDs 63e and 63f positioned in the ultraviolet irradiator 6b of the area B3 are turned on. Furthermore, the second discharge area A2-b discharges clear ink droplets and simultaneously the UVLEDs 63g and 63h positioned in the ultraviolet irradiator 6b of the area B4 are turned on (step S31). When the carriage 4 moves backward in the main scanning direction (S), the UVLEDs 63 irradiating ultraviolet rays on the band recorded in the step S31 are turned on (step S32). When the carriage 4 moves backward in the main scanning direction (S), the UVLEDs 63 of at least one of the ultraviolet irradiators 6a and 6b can be turned on. The fourth path record is made by the clear ink discharged from the second discharge area A2-b on the band on which the third path record is made by the clear ink discharged from the second discharge area A2-a during the previous scan. This clear ink is cured in a particle shape by irradiating ultraviolet rays after being deposited on the medium (M). Thus, the second layer of coating by clear ink on the images is generated. In the fourth scan, the first path record is made by the color ink discharged from the first discharge area A1-a (similar to first scan). The second path record is made by the color ink discharged from the first discharge area A1-b (similar to second scan). The third path record is made by the clear ink discharged from the second discharge area A2-a (similar to third scan).

After the back-and-forth motion of the carriage 4 in the main scanning direction (S) is completed, since this scan is the fourth scan of the image recording coating process (β1), it is determined whether the Y bar 3 has moved in the sub-scanning direction (F) for the predetermined number of times (step S33).

If it is determined that the Y bar 3 has not moved in the sub-scanning direction (F) for the predetermined number of times (step S33: No), the Y bar 3 is moved forward in the sub-scanning direction (F) by one band (path width) (step S34) and the step S31 is repeated. Since the carriage 4 mounted on the Y bar 3 is moved by one band in the sub-scanning direction (F), the inkjet heads 5 and the ultraviolet irradiators 6 correspond to the next path line and a recording position with respect to the medium (M) moves forward in the sub-scanning direction (F). The steps S31 to S33 are repeated until it is determined in the step S33 that the Y bar 3 has moved in the sub-scanning direction (F) for the predetermined number of times.

If it is determined that the Y bar 3 has moved in the sub-scanning direction (F) for the predetermined number of times (step S33: Yes), the Y bar 3 returns to the original position (print starting position of step S31) (step S35) by moving backward in the sub-scanning direction (F) and the thick image process (β2) begins by sequentially moving the Y bar 3 in the sub-scanning direction (F).

As shown in FIG. 19(B), in the first scan of the thick image process (β2), no ink is discharged and no ultraviolet rays are irradiated. The carriage 4 moves forward and backward in the main scanning direction (S) (steps S36 and S37). The fifth path idling is made on the band located in the most backward region in the sub-scanning direction (F). The idling means the back-and-forth motion of the carriage 4 without discharging ink and without ultraviolet ray irradiation.

After the back-and-forth motion of the carriage 4 in the main scanning direction (S) is completed, it is determined whether the Y bar 3 has moved in the sub-scanning direction (F) for a predetermined number of times (step S38). A plurality of divided bands for printing data are recorded by sequentially moving the Y bar 3 forward in the sub-scanning direction (F) in the thick image process (β2). The recordation of each band is completed in four scans (four paths) because the two path idling is made on the band in the first two scans and the two path recordation is made by the clear ink on the band in the next two scans. Thus, it is determined that the Y bar 3 has moved in the sub-scanning direction (F) for a predetermined number of times after the fourth scan in the step S38 and the predetermined number of times is calculated by adding the number of the divided printing data and three.

Since this scan is the first scan of the thick image process (β2), it is determined that the Y bar 3 has not moved in the sub-scanning direction (F) for the predetermined number of times (step S38; No). The Y bar 3 is moved by one band (path width) in the sub-scanning direction (F) (step S39) and the step S36 is repeated. Since the carriage 4 mounted on the Y bar 3 is moved by one band in the sub-scanning direction (F), the inkjet heads 5 and the ultraviolet irradiators 6 correspond to the next path line and a recording position with respect to the medium (M) moves forward in the sub-scanning direction (F).

In the second scan of the thick image process (β2), no ink is discharged and no ultraviolet rays are irradiated. The carriage 4 moves back and forth in the main scanning direction (S) (step S36 and S37). The sixth path idling is made on the band positioned in the most backward region in the sub-scanning direction (F). The fifth path idling is made on a neighboring band positioned in the forward region in the sub-scanning direction (F).

After the back-and-forth motion of the carriage 4 in the main scanning direction (S) is completed, since this scan is the second scan of the thick image process (β2), it is determined that the Y bar 3 has not moved in the sub-scanning direction (F) for the predetermined number of times (step S38: No). The Y bar is moved by one band (path width) in the sub-scanning direction (F) (step S39) and the step S36 is repeated. Since the carriage 4 mounted on the Y bar 3 is moved by one band in the sub-scanning direction (F), the inkjet heads 5 and the ultraviolet irradiators 6 correspond to the next path line and a recording position with respect to the medium (M) moves forward in the sub-scanning direction (F).

In the third scan of the thick image process (β2), when the carriage 4 moves forward in the main scanning direction (S), the second discharge area A2-a discharges clear ink droplets and simultaneously the UVLEDs 63e and 63f positioned in the ultraviolet irradiator 6b of the areas B3 are turned on (step S35). When the carriage 4 moves backward in the main scanning direction (S), the UVLEDs 63 irradiating ultraviolet rays on the band recorded in the step S35 are turned on (step S36). When the carriage 4 moves backward in the main scanning direction (S), the UVLEDs 63 of at least one of the ultraviolet irradiators 6a and 6b are turned on. Then, the seventh path record is made by the clear ink discharged from the second discharge area A2-a on the band on the most backward position in the sub-scanning direction (F). This clear ink is cured in a particle shape by irradiating ultraviolet rays after being deposited on the medium (M). Thus, the images recorded in the image recording coating process (β1) are thickened by one layer.

After the back-and-forth motion of the carriage 4 in the main scanning direction (S) is completed, since this scan is the third scan of the thick image process (β2), it is determined that the Y bar 3 has not moved in the sub-scanning direction (F) for the predetermined number of times (step S38: No). The Y bar is moved by one band (path width) in the sub-scanning direction (F) (step S39) and the step S36 is repeated. Since the carriage 4 mounted on the Y bar 3 is moved by one band in the sub-scanning direction (F), the inkjet heads 5 and the ultraviolet irradiators 6 correspond to the next path line and a recording position with respect to the medium (M) moves forward in the sub-scanning direction (F).

In the fourth scan of the thick image process (β2), when the carriage 4 moves forward in the main scanning direction (S), the second discharge area A2-a discharges clear ink droplets and simultaneously the UVLEDs 63e and 63f positioned in the ultraviolet irradiator 6b of the area B3 are turned on. Furthermore, the second discharge area A2-b discharges clear ink droplets and simultaneously the UVLEDs 63g and 63h positioned in the ultraviolet irradiator 6b of the area B4 are turned on (step S35). When the carriage 4 moves backward in the main scanning direction (S), the UVLEDs 63 irradiating ultraviolet rays on the band recorded in the step S35 are turned on (step S36). When the carriage 4 moves backward in the main scanning direction (S), the UVLEDs 63 of at least one of the ultraviolet irradiators 6a and 6b are turned on. Then, the eighth path record is made by the clear ink discharged from the second discharge area A2-b on the band on which the seventh path is made by the clear ink discharged from the second discharge area A2-a during the previous scan. This clear ink is cured in a particle shape by irradiating ultraviolet rays after being deposited on the medium (M). In this fourth scan, the seventh path record is made by the clear ink discharged from the second discharge area A2-a (similar to third scan).

After the back-and-forth motion of the carriage 4 in the main scanning direction (S) is completed, since this scan is the fourth scan of the thick image process (β2), it is determined whether the Y bar 3 has moved in the sub-scanning direction (F) for the predetermined number of times (step S38).

If it is determined that the Y bar 3 has not moved in the sub-scanning direction (F) for the predetermined number of times (step S38: No), the Y bar is moved by one band (path width) in the sub-scanning direction (F) (step S39) and the step S36 is repeated. Since the carriage 4 mounted on the Y bar 3 is moved by one band in the sub-scanning direction (F), the inkjet heads 5 and the ultraviolet irradiators 6 correspond to the next path line and a recording position with respect to the medium (M) moves forward in the sub-scanning direction (F). The steps of S36 to S38 are repeated until it is determined in the step S38 that the Y bar 3 has moved in the sub-scanning direction (F) for the predetermined number of times.

Here, if the final scan is the (m)th scan, a method of recording the final band by the image recording process (α1) will now be described.

In the final (m)th scan, when the carriage 4 moves forward in the main scanning direction (S), the second discharge area A2-a discharges clear ink droplets and simultaneously the UVLEDs 63e and 63f positioned in the area B3 are turned off. Furthermore, the second discharge area A2-b discharges clear ink droplets and simultaneously the UVLEDs 63g and 63h positioned in the ultraviolet irradiator 6b of the area B4 are turned on (step S36). When the carriage 4 moves backward in the main scanning direction (S), only the UVLEDs 63g and 63h positioned in the area B4 are turned on (step S37). Then, the eighth path record is made by the clear ink discharged from the second discharge area A2-b on the final band is recorded by the clear ink discharged from the second discharge area A2-a and irradiated ultraviolet rays by the UVLEDs 63g and 63h positioned in the area B4 during the previous scan.

Thus, a single image recording process (α1) in the thick image process (β2) is completed while the second discharge area A2-b is positioned on the final band path line.

If it is determined that the Y bar 3 has moved in the sub-scanning direction (F) for the predetermined number of times (step S38: Yes), it is determined whether the thick image process (β2) has been made for a predetermined number of times (step S40). Here, in order to thicken the clear ink into a predetermined thickness, the thick image process (β2) is repeated as many times as required. The number of the times required is specified by a predetermined value or a value determined in printing data. Thus, if the number of this thick image process (β2) has not reached the predetermined number in the step S40, it is determined that the thick image process (β2) has not been performed for the predetermined number of times. If the number of the thick image process (β2) has reached the predetermined number, it is determined that the thick image process (β2) has been performed for the predetermined number.

If it is determined that the thick image process (β2) has not been performed for the predetermined number of times (step S40: No), the steps S35 to S40 are repeated.

If it is determined that the thick image process (β2) has been performed for the predetermined number of times (step S40: Yes), the gloss process (β3) is made by sequentially moving the Y bar 3 backward in the sub-scanning direction (F).

As shown in FIG. 19(C), in the first scan of the gloss process (β3), when the carriage 4 moves forward in the main scanning direction (S), the second discharge area A2-b discharges clear ink droplets and simultaneously the UVLEDs 63g and 63h positioned in the ultraviolet irradiators 6a and 6b of the area B4 are turned off (step S41). When the carriage 4 moves backward in the main scanning direction (S), the UVLEDs 63g and 63h positioned in the step S41 are turned off (step S42). Then, the second discharge area A2-b is positioned on the final band path line of the thick image process (β2). Thus, if the number of all the paths in the thick image mode is n, (n-3)th path record is made by the clear ink discharged from the second discharge A2-b on the final band of the thick image process (β2) located on the most forward region in the sub-scanning direction (F). Then, since the UVLEDs 63g and 63h positioned in the area B4 which irradiates ultraviolet rays on the band on which the second discharge area A2-b discharges the clear ink are turned off, the clear ink discharged on the medium (M) in the (n-3)th path is not cured. Its thickness becomes thinner and the uneven surface is smoothened. In the first scan, the UVLEDs 63a-63d positioned in the areas B1 and B2 can be turned on or off.

After the back-and-forth motion of the carriage 4 in the main scanning direction (S) is completed, it is determined whether the Y bar 3 has moved backward in the sub-scanning direction (F) for the predetermined number of times (step S43). A plurality of divided bands for printing data are recorded by sequentially moving the Y bar 3 backward in the sub-scanning direction (F) in the gloss process (β3). The recordation of each band is completed in four scans (four paths) because the two path recordation is made by the clear ink on the band in the first two scans and the two path irradiation is made on the recorded clear ink in the next two scans. Thus, it is determined that the Y bar 3 has moved backward in the sub-scanning direction (F) for the predetermined number of times after the fourth scan in the step S43 and the predetermined number in the gloss process (β3) is calculated by adding the number of the divided printing data and three.

Since this scan is the first scan of the gloss process (β3), it is determined that the Y bar 3 has not moved backward in the sub-scanning direction (F) for the predetermined number of times (step S43: No). The Y bar 3 is moved backward by one band (path width) in the sub-scanning direction (F) (step S44) and the step S41 is repeated. Since the carriage 4 mounted on the Y bar 3 is moved backward by one band in the sub-scanning direction (F), the inkjet heads 5 and the ultraviolet irradiators 6 correspond to the next path line and a recording position with respect to the medium (M) moves backward in the sub-scanning direction (F).

In the second scan of the gloss process (β3), when the carriage 4 moves forward in the main scanning direction (S), the second discharge area A2-b discharges clear ink droplets and simultaneously the UVLEDs 63g and 63h positioned in the ultraviolet irradiators 6a and 6b of the area B4 are turned off. Furthermore, the second discharge area A2-a discharges clear ink droplets and simultaneously the UVLEDs 63e and 63f positioned in the ultraviolet irradiators 6a and 6b of the area B3 are turned off (step S41). When the carriage 4 moves backward in the main scanning direction (S), the UVLEDs 63e-63h positioned on the band recorded by the clear ink in the step S41 are turned off (step S42). The (n-2)th path record is made by the clear ink discharged from the second discharge area (A2-a) on the band on which the (n-3)th path record is made by the clear ink discharged from the second discharge area (A2-b) during the first scan. Thus, the UVLEDs 63e and 63f are positioned in the area B3 to irradiate ultraviolet rays on the band to which the second discharge A2-a discharges the clear ink. Since such UVLEDs 63e and 63f are turned off, the clear ink discharged on the medium (M) in the (n-2)th path is not cured but its thickness with the clear ink in the (n-3)th path becomes thinner and the uneven surface is smoothened. In the second scan, (n-3)th path is made by the clear ink discharged from the second discharge area A2-b (similar to first scan). Meanwhile, in the second scan, the UVLEDs 63a-63d positioned in the areas B1 and B2 can be turned on or off.

After the back-and-forth motion of the carriage 4 in the main scanning direction (S) is completed, since this scan is the second scan of the gloss process (β3) (step S43: No), the Y bar 3 is moved backward by one band (path width) in the sub-scanning direction (F) (step S44) and the step S41 is repeated. Since the carriage 4 mounted on the Y bar 3 is moved backward by one band in the sub-scanning direction (F), the inkjet heads 5 and the ultraviolet irradiators 6 correspond to the next path line and a recording position with respect to the medium (M) moves backward in the sub-scanning direction (F).

In the third scan of the gloss process (β3), when the carriage 4 moves forward in the main scanning direction (S), the second discharge areas A2-a and A2-b discharge clear ink droplets and simultaneously the UVLEDs 63e-63h positioned in the ultraviolet irradiators 6a and 6b of the areas B3 and B4 are turned off. Furthermore, the UVLEDs 63c and 63d positioned in the area B2 are turned on (step S41). When the carriage 4 moves backward in the main scanning direction (S), the UVLEDs 63c and 63d positioned in the area B2 are turned on (step S42). The UVLEDs 63c and 63d of at least one of the ultraviolet irradiators 6a and 6b can be turned on. Then, (n-1)th path is made by the ultraviolet rays irradiated from the UVLEDs 63c and 63d of the area B2 on the band on which the (n-2)th path record is made by the clear ink discharged from the second discharge area A2-a during the second scan. The clear ink of the (n-3)th path and (n-2)th path is sufficiently smoothened and cured. In this third scan, the (n-3)th path record is made by the clear ink discharged from the second discharge area A2-b (similar to first scan) and the (n-2)th path record is made by the clear ink discharged from the second discharge area A2-a (similar to second scan).

After the back-and-forth motion of the carriage 4 in the main scanning direction (S) is completed, since this scan is the third scan of the gloss process (β3) (step S43: No), the Y bar 3 is moved backward by one band (path width) in the sub-scanning direction (F) (step S44) and the step S41 is repeated. Since the carriage 4 mounted on the Y bar 3 is moved backward by one band in the sub-scanning direction (F), the inkjet heads 5 and the ultraviolet irradiators 6 correspond to the next path line and a recording position with respect to the medium (M) moves backward in the sub-scanning direction (F).

In the fourth scan of the gloss process (β3), when the carriage 4 moves forward in the main scanning direction (S), the second discharge areas A2-a and A2-b discharge clear ink droplets and simultaneously the UVLEDs 63e-63h positioned in the ultraviolet irradiators 6a and 6b of the areas B3 and B4 are turned off. The UVLEDs 63c and 63d positioned in the area B2 are turned on. Furthermore, the UVLEDs 63a and 63b positioned in the area B1 are turned on (step S41). When the carriage 4 moves backward in the main scanning direction (S), the UVLEDs 63a-63d positioned in the areas B1 and B2 are turned on (step S42). The UVLEDs 63a-63d of at least one of the ultraviolet irradiators 6a and 6b can be turned on. Then, the final nth path is made by ultraviolet rays irradiated from the UVLEDs 63a and 63b on the band irradiated by ultraviolet rays from the UVLEDs 63c and 63d positioned in the area B2 during the third scan. The clear ink is sufficiently cured. In the fourth scan, the (n-3)th path record is made by the clear ink discharged from the second discharge area A2-b (similar to first scan). The (n-2)th path record is made by the clear ink discharged from the second discharge area A2-a (similar to second scan). The band on which the (n-2)th path is made is irradiated by ultraviolet rays (similar to third scan).

After the back-and-forth motion of the carriage 4 in the main scanning direction (S) is completed, since this scan is the fourth scan of the gloss process (β3), it is determined whether the Y bar 3 has moved backward in the sub-scanning direction (F) for the predetermined number of times (step S43).

If it is determined that the Y bar 3 has not moved backward in the sub-scanning direction (F) for the predetermined number of times (step S43: No), the Y bar 3 is moved backward by one band (path width) in the sub-scanning direction (F) (step S44), and the step S41 is repeated. Then since the carriage 4 has moved backward by one band in the sub-scanning direction (F), the inkjet heads 5 and the ultraviolet irradiators 6 correspond to the next path line and a recording position with respect to the medium (M) moves backward in the sub-scanning direction (F). The steps of S41 to S43 are repeated until it is determined in the step S43 that the Y bar 3 has moved backward in the sub-scanning direction (F) for the predetermined number of times.

However, if it is determined that the Y bar 3 has moved backward in the sub-scanning direction (F) for the predetermined number of times (step S43: Yes), the printing process in the gloss image mode is terminated.

Thus, since a layer of the clear ink on the upper layer of the image recorded on the medium (M) is laminated and the smoothened clear ink is recorded on the upper layer, the image visibility is enhanced, the layer of the clear ink is thickened, and the image can be glossy.

Meanwhile, it is preferred that, in the steps S41 and S42, the amount of ultraviolet rays emitted from the UVLEDs 63c and 63d positioned in the area B2 is less than that of ultraviolet rays emitted from the UVLEDs 63a and 63b positioned in the area B1 (similar to steps S15 and S16). In the thick image process (β2) prior to the gloss process (β3), the speed of smoothening the clear ink can increase because the upper layer of the clear ink becomes active by curing the particles of the lower layer of the clear ink.

According to the inkjet recording apparatus 1 of the present disclosure, since the UVLEDs 63 are positioned to control each corresponding band, the ultraviolet irradiation for each band can be turned on or off. Thus, since the ULVEDs 63 irradiating ultraviolet rays on a band located in a path area to which ink droplets are discharged are turned off, the ink droplets discharged to the path area are not cured after being deposited on the medium (M) and smoothened. Therefore, recording can be made with sufficient gloss. Since the UVLEDs 63 irradiating ultraviolet rays on a band in a path area to which ink droplets are discharged are turned on, the ink droplets discharged to the path area are cured after being deposited on the medium (M) and the matte images can be recorded.

The ink does not smear but records clear color image because the color ink discharged from the first discharge area A1 is cured after being deposited on the medium (M) by turning on the ULVEDs 63 in the areas B1 and B2. A lower layer of the images can become sufficiently glossy because the clear ink discharged from the second discharge area A2 is not cured after being deposited on the medium (M) and smoothened.

The clear ink deposited on the medium (M) can be cured by irradiating ultraviolet rays in the next scan because the second discharge area A2 discharges clear ink and the Y bar 3 moves backward in the sub-scanning direction (F). Thus, gloss recording can be efficiently made because discharging clear ink and curing the smoothened clear ink can be made while the Y bar 3 does not change direction.

In the gloss image mode, since the smoothened clear ink is recorded on the upper layer of the images recorded on the medium (M), the image visibility is enhanced and the image can be glossy.

The first discharge area A1 discharges color ink and the second discharge area A2 discharges clear ink. Thus, when the Y bar 3 moves in the sub-scanning direction (F), the color ink is recorded on the medium (M), and when the Y bar moves backward in the sub-scanning direction (F), this clear ink is recorded on the upper layer of the color ink. Since one motion of the Y bar 3 moving back and forth records image and generates gloss, glossy image recording can be efficiently made.

In the thick image mode, since a layer of the clear ink on the upper layer of the image recorded on the medium (M) is laminated and the smoothened clear ink is recorded on the upper layer, the image visibility is enhanced, the layer of the clear ink is thickened, and the image becomes glossy.

All the ink droplets discharged from the ink nozzles can be cured by moving the carriage 4 back and forth in the main scanning direction (S) in a single scan because the ultraviolet irradiators 6 are positioned in the forward and backward regions of the first and second discharge areas Al and A2 in the main scanning direction (S).

The embodiment of the present disclosure has been described above and the present disclosure is not only limited to the embodiments. For example, a number and positions of the UVLEDs 63 arranged in the ultraviolet irradiators 6, a number and positions of the partition walls 64 inserted in the ultraviolet irradiators 6, and the intensity distribution of the ultraviolet irradiation for controlling each UVLEDs 63 can be appropriately determined depending on image qualities.

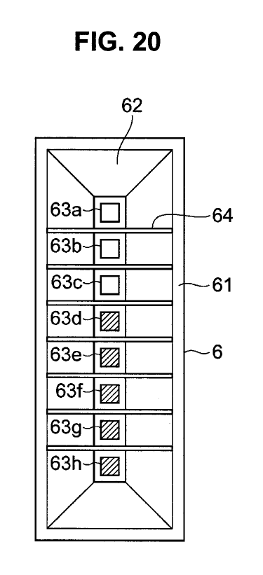

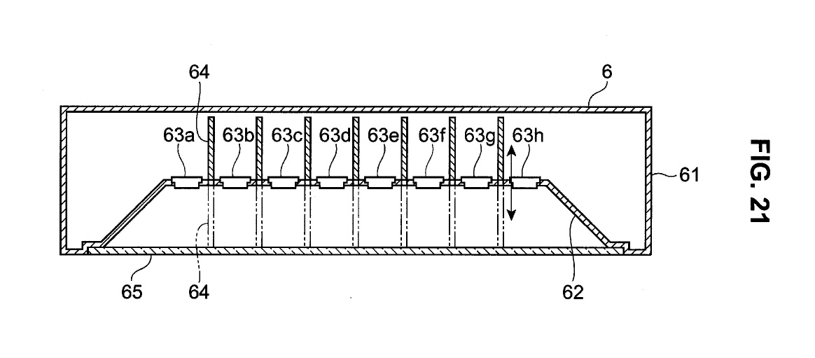

According to the embodiment, although three partition walls 64 are inserted in the ultraviolet irradiators 6, there can be any number of the partition walls 64. As shown in FIG. 20, seven partition walls 64 can be inserted. In such case, the amount of the ultraviolet rays from the UVLEDs 63 positioned in the area B2 can be effectively reduced by turning on the UVLEDs 63a-63c and turning off the UVLEDs 63d-63h in the coating process (α2) of the gloss image mode.

According to the embodiment of the present disclosure, although ink droplets are discharged only when the carriage 4 moves forward in the main scanning direction (S), the ink droplets can be discharged when the carriage 4 moves both forward and backward in the main scanning direction (S).

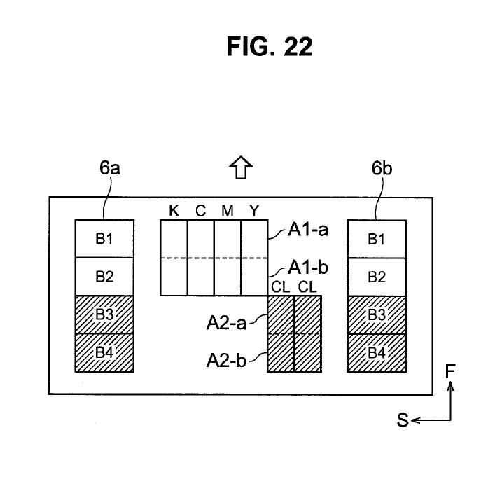

According to the embodiment of the present disclosure, although all of the UVLEDs 63 are turned on in the image recording process (α1) of the gloss image mode, the UVLEDs 63 positioned in the areas B3 and B4 can be turned off to suppress over-curing color ink, as shown in FIG. 22. Thus, the adherence of color ink and clear ink can be improved by suppressing the over-curing color ink because the color ink is not irradiated by ultraviolet rays until the coating process (α2) after the ultraviolet rays are irradiated during the second path recordation.

According to the embodiment of the present disclosure, although the image recording coating process (β1), the thick image process (β2), and gloss process (β3) are explained for the thick image mode, the thick image process (β2) is not required. For example, the image recording coating process (β1) and gloss process (β3) can be made for the thick image mode.

According to the embodiment of the present disclosure, although inserting and removing the partition walls 64 in the ultraviolet irradiators 6 is not described in detail, the partition walls 64 can be inserted or removed from the opening area of the concave portion 62 after the cover 65 is taken off or the partition walls 64 can be inserted or removed through the main body 61 to the concave portion 62, as shown in FIG. 21. In such case, the insertion and removal of each partition wall 64 can be controlled by an actuator or a lead screw. Or, physically, each partition wall 64 can have a handle that extends out of the main body 61 for the insertion and removal.

According to the embodiment of the present disclosure, although the partition wall 64 has a trapezoidal shape, it can have any kind of shape as long as the ultraviolet rays are shielded.

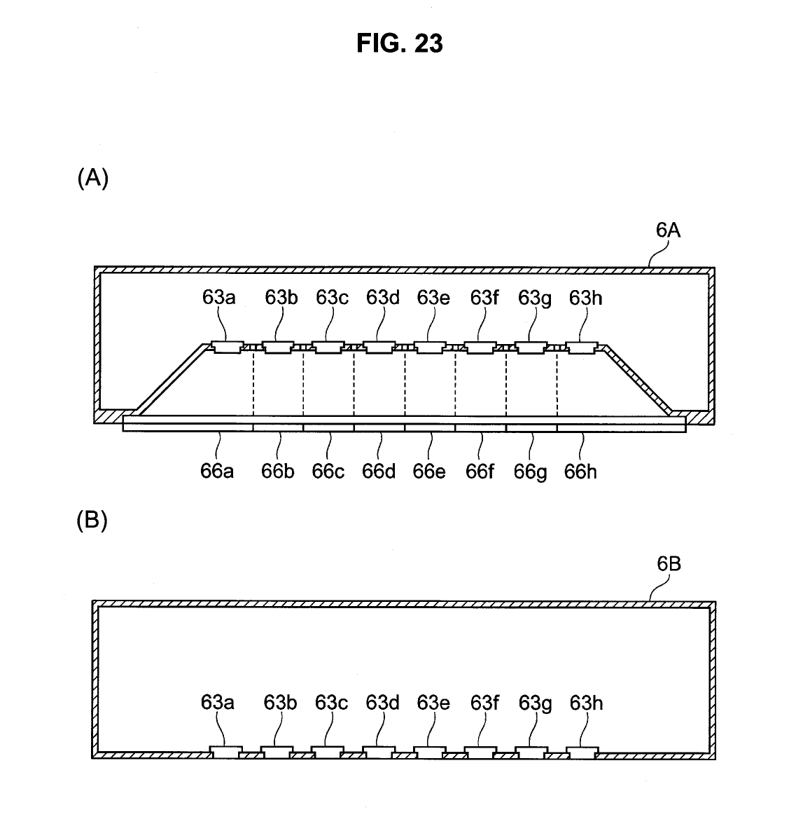

In the embodiments described above, the partition walls 64 are provided in the ultraviolet irradiator 6 and the partition walls 64 control irradiation of the ultraviolet rays emitted from the UVLEDs 63 in the sub-scanning direction (F). However, the partition walls 64 are not essential elements of the embodiments of the present disclosure and can be replaced by light-controlling individual UVLEDs 63 such that irradiation intensity of the ultraviolet rays to the ultraviolet-curable ink in the sub-scanning direction (F) can be changed. For example, in the ultraviolet irradiator 6A shown in FIG. 23(A), shields 66a to 66h are provided vertically below the UVLEDs 63a to 63h, respectively, in the vertical direction. The irradiation intensity of the ultraviolet rays in the sub-scanning direction (F) can be changed by blocking irradiation of the ultraviolet rays from adjacent UVLEDs 63 toward the bottom portion vertically below the UVLED 63 which is turned off. In addition, the ultraviolet irradiator 6B shown in FIG. 23(B) does not have any concave portion. Rather, the UVLEDs 63a to 63h are provided on the bottom side of the ultraviolet irradiator 63. The irradiation intensity of the ultraviolet rays in the sub-scanning direction (F) can be changed by blocking irradiation of the ultraviolet rays from adjacent UVLEDs 63 to the bottom portion vertically below the UVLED 63 which is turned off.

According to the embodiment of the present disclosure, although the ultraviolet irradiators 6 are positioned in the forward and backward regions in the main scanning direction (S) with respect to the inkjet heads 5, the ultraviolet irradiator can be positioned in one of the forward and backward regions.

According to the embodiment of the present disclosure, although the ultraviolet irradiators 6a and 6b are identical, they do not need to be identical and can be different from each other as long as they are within the scope of the present disclosure.

According to the embodiment of the present disclosure, a band recorded by color ink and a band recorded by clear ink are offset in the sub-scanning direction (F) by specifying discharge areas for ink droplets from the ink nozzles 8 mounted in each inkjet head 5. However, a band recorded by color ink and a band recorded by clear ink can be offset in the sub-scanning direction (F) by physically offsetting the band recorded by color ink and the band recorded by clear ink in the sub-scanning direction (F).

According to the embodiment of the present disclosure, although the nozzle lines of the ink nozzles 8 for each band are arranged as a straight line in the main scanning direction (S), the nozzle lines of the ink nozzles 8 for one or a plurality of the bands can be offset in the main scanning direction (S) by arranging the inkjet heads 5 on a plurality of nozzle lines in the main scanning direction (S). Also, according to the embodiment, although the color ink nozzles 8 and the clear ink nozzles 8 are offset in the main scanning direction (S), these ink nozzles 8 can be arranged as a straight line in the sub-scanning direction (F). In that case, ink nozzles for color ink and ink nozzles for clear ink can be positioned in different inkjet heads or in the same inkjet heads.

According to the embodiment of the present disclosure, although the ULVEDs 63 are used for the light sources of the ultraviolet irradiators 6, any means such as UV lamps can be used as long as ultraviolet rays can be emitted.

According to the embodiment of the present disclosure, the inkjet heads 5 and the medium (M) are moved with respect to each other in the sub-scanning direction (F) while the Y bar 3 moves the inkjet heads 5. However, at least one of the inkjet heads 5 and the medium (M) or both can be moved. For example, a grid rolling type can be used to move the inkjet heads 5 and the medium (M) with respect to each other in the sub-scanning direction (F) by moving the medium (M).

What is claimed is:

1. An inkjet recording apparatus comprising:
a carriage moving back and forth in a main scanning direction;
ink discharging means mounted on the carriage and comprising a plurality of ink nozzles arranged in a sub-scanning direction for discharging ultraviolet-curable ink on a recording medium;
ultraviolet irradiating means mounted on the carriage for irradiating ultraviolet rays on the medium; and
a controller controlling operation of the ink discharging means and the ultraviolet irradiating means,
wherein the carriage or the medium moves in the sub-scanning direction which is perpendicular to the main scanning direction,
wherein the plurality of ink nozzles comprise a plurality of path areas to record a plurality of bands,
wherein the ultraviolet irradiating means comprises a plurality of light sources irradiating the ultraviolet rays on the plurality of bands, respectively,
wherein the controller controls at least one of the light sources for each path area discharging ultraviolet-curable ink.

2. The inkjet recording apparatus of claim 1, wherein while the carriage moves forward in the main scanning direction, a path area in a downstream region in the sub-scanning direction discharges the ink on a first band, a light source irradiating on the first band is turned off, a path area in an upstream region in the sub-scanning direction discharges no ink on a second band, and a light source irradiating on the second band is turned on.

3. The inkjet recording apparatus of claim 1 or 2, wherein a color ultraviolet-curable ink is recorded on the medium to form a lower layer and a clear ultraviolet-curable ink is recorded on the lower layer to form an upper layer, and a light source irradiating on a band corresponding to a path area discharging the color ink is turned on, and a light source irradiating on a band corresponding to a path area discharging the clear ink is turned off.

4. The inkjet recording apparatus of claim 3, wherein a path area in a downstream region in the sub-scanning direction discharges the clear ink on a third band, a light source irradiating on the third band is turned off, and a light source irradiating on a fourth band corresponding to a path area in a upstream region in the sub-scanning direction is turned on.

5. The inkjet recording apparatus of claim 4, wherein first and second light sources irradiating on fifth and sixth bands corresponding to path areas in a upstream region in the sub-scanning direction are turned on, and a light intensity of one of the first and second light sources which is located in a more downstream region in the sub-scanning direction is less than a light intensity of the other light source.

6. The inkjet recording apparatus of claim 1, wherein color ultraviolet-curable ink is recorded on the medium by discharging the color ink on a first band from a path area in a downstream region in the sub-scanning direction, and turning on a light source irradiating on the first band, wherein clear ultraviolet-curable ink is recorded on a layer formed by the recorded color ink by discharging the clear ink on a second band from a path area in a downstream region in the sub-scanning direction, turning on a light source irradiating on a third band corresponding to a path area in an upstream region in the sub-scanning direction, and turning off a light source irradiating on the second band.

7. The inkjet recording apparatus of claim 1, wherein color ultraviolet-curable ink is recorded on the medium by moving the carriage or the medium forward in the sub-scanning direction, discharging the color ink on a first band from a path area in a forward region in the sub-scanning direction, and turning on a light source irradiating on the first band, wherein clear ultraviolet-curable ink is recorded on a layer formed by the recorded color ink by moving the carriage or the medium backward in the sub-scanning direction, discharging the clear ink on a second band from a path area in a backward region in the sub-scanning direction, turning on a light source irradiating on a third band corresponding to a path area in an upstream region in the sub-scanning direction, and turning off a light source irradiating on the second band.

8. The inkjet recording apparatus of claim 1, wherein color ultraviolet-curable ink is recorded on the medium and simultaneously first clear ultraviolet-curable ink is recorded on a color ink layer formed by the recorded color ink by discharging the color ink on a first band from a path area in a downstream region in the sub-scanning direction, discharging the clear ink on a second band from a path area in a upstream region in the sub-scanning direction, and turning on light sources irradiating on the first and second bands, wherein second clear ultraviolet-curable ink is recorded on a clear ink layer formed by the recorded first clear ink by discharging the second clear ink on a third band from a path area in a downstream region in the sub-scanning direction, turning on a light source irradiating on a fourth band in a upstream region in the sub-scanning direction, and turning off a light source irradiating on the third band.

9. The inkjet recording apparatus of claim 1, wherein a light source irradiating on a band corresponding to a path area discharging first ultraviolet-curable ink to form a lower layer is turned on and a light source irradiating on a band corresponding to a path area discharging second ultraviolet-curable ink to form an upper layer is turned off.

10. A print method using an inkjet recording apparatus of any one of claims 1 to 9, the method comprising:
recording clear ultraviolet-curable ink on the medium in a current scan by turning off a first light source irradiating on a first band corresponding to a path area discharging the clear ink in a downstream region in the sub-scanning direction; and
curing the clear ink recorded on the medium in a next scan by turning on a second light source irradiating on a second band corresponding to a path area in an upstream region in the sub-scanning direction.

11. The print method of claim 10, further comprising:
curing the clear ink recorded on the medium in the next scan by turning on a third light source irradiating on a third band corresponding to a path area in an upstream region in the sub-scanning direction, wherein a light intensity of one of the second and third light sources which is located in a more downstream area is less than a light intensity of the other light source.
